(19) United States
(12) Patent Application Publication
(10) Pub. No.: US 2019/0138282 A1
(43) Pub. Date: May 9, 2019

(54) SYSTEM AND METHODS FOR DEVELOPMENT OF VISUAL BUSINESS APPLICATIONS

(71) Applicant: Pablo Daniel Palma Keller, Santiago (CL)

(72) Inventor: Pablo Daniel Palma Keller, Santiago (CL)

(21) Appl. No.: 16/181,091

(22) Filed: Nov. 5, 2018

Related U.S. Application Data
(63) Continuation-in-part of application No. 15/468,351, filed on Mar. 24, 2017.
(60) Provisional application No. 62/313,178, filed on Mar. 25, 2016.

(51) Int. Cl. G06F 8/34; G06F 8/41

(52) U.S. Cl. CPC G06F 8/34; G06F 8/41

(57) ABSTRACT

A system and methods for the development of data processing applications are provided. In some embodiments, the system is represented as a “Head” that exchanges data with an “App Infrastructure”, such that the Business Logic is represented in the Business Rules and in the App Infrastructure all computational elements needed to generate and use the data exchanged with the Head, are represented. The system represents business rules, uses in original form some graphic elements that make unnecessary the use of “textual programming languages.” For this reason, the Business Applications developed with the system and methods can be understood and maintained by a Business Analyst. The system and methods do not provide capabilities or impose restrictions on how the App Infrastructure is built, activity that is addressed with the most appropriate technologies for each particular problem, and therefore this activity remains in the traditional IT field.

### CROSS REFERENCE TO RELATED APPLICATIONS

This application claims priority to and the benefit of the filing date of U.S. Non-Provisional application Ser. No. 15/468,351, filed on Mar. 24, 2017, entitled “SYSTEM AND METHODS FOR DEVELOPMENT OF VISUAL BUSINESS APPLICATIONS”, which claims priority to and the benefit of U.S. Provisional Application No. 62/313,178, filed on Mar. 25, 2016, entitled “SYSTEM AND METHODS FOR DEVELOPMENT OF VISUAL BUSINESS APPLICATIONS”, the entire disclosures of which are incorporated by reference herein.

### BACKGROUND OF THE INVENTION

Generally, Enterprise Applications, also called business applications, consist of computer programs that are built by specialized personnel who may be called programmers, software engineers or more generally, IT specialists. To build computer programs, these specialists can use different programming languages, some of which are named by way of example: C, C++, Basic, Fortran, Algol, Lisp, Java, JavaScript, Haskell, etc. To understand what these programs do, or to modify these programs, a person usually needs to have specialized technical capabilities that in many respects are similar or equivalent to having programmers, software engineers or IT specialists.

Business applications can support different businesses that run on Companies. This means that different types of people such as employees, customers, suppliers, can use the business application to perform various actions that are considered part of the business.

Generally, within companies there are people who can define, or execute, or modify, or make other types of actions related to the definitions of the business, here on called business analysts. They can use any of a variety of different ways to record the definitions of the business, which can be manual or automated.

Business analysts may not have the IT knowledge required to understand or modify computer programs that are part of the business application.

Generally, for the same business in a company, the knowledge and information about the business application that supports the business, handled by business analysts and IT specialists can be substantially different. This situation can cause significant inefficiencies. Currently, another type of technology named LOW CODE is being used to reduce dependency on IT specialists and IT knowledge. Examples of low code solutions are OutSystems, KissFlow, ApZoho Creator, Google App Builder, etc. Low code is aimed to fully replace current development technologies, instead of segregating only the business logic while keeping untouched the remainder of the application. The last characteristic makes low code an invasive solution.

### BRIEF SUMMARY OF THE INVENTION

On the one hand, a method is provided to identify and represent the Business Logic of a business application is provided. A preferred embodiment is that this representation is graphic, and can use items such as “mental maps” or blocks that could be as those of Blockly (a graphical platform from Google), or a structure of boxes for representing complex conditions. This representation can be developed and modified by a Business Analyst and can be understood by anyone who knows the business.

On the other hand, a System is provided that gives computer support to the Business Logic, making executable the graphic representation by mental maps, blocks and structure of boxes.

A system and method to develop visual business applications is provided. This allows large applications development using a graphical representation of the problem. The method focuses on what we call the “Business Logic” which typically represents 10% of the code of a business application that is represented with graphic objects that automatically generate a program that is executed by the computer. Program execution could be done in the Cloud. Business Rules are part of the Business Logic, being the objects declaring how the domain is maintained, which is what controls the aim and purpose of the business.

The methods allow, no matter the complexity of the application, for it to always be possible to focus on specific aspects, according to the interests of the specialist working with it and is an advanced form of knowledge management encapsulated in the enterprise application.

A system and method for the development of business applications is provided. In some embodiments, a business application generated by the system may be represented as a “Business Logic” that exchanges data with an “App Infrastructure”, such that in the Business Logic the business rules are represented, and in the App Infrastructure are represented all computational elements needed to generate and use the data exchanged with the Business Logic. The system is configured to represent business rules, used in a particular form, and graphic elements to generate a business application without the need for the use of “textual programming languages.” For this reason, the business applications generated with the system and methods can be understood and maintained by a business analyst. The system and methods do not limit capabilities or impose restrictions on how the App Infrastructure is built, activity that is addressed with the most appropriate technologies for each particular problem, and therefore this activity remains in the traditional IT field.

In some embodiments, a computer implemented system for development of visual business applications is provided. The system may include an electronic device having a display screen and an input interface for receiving input from a user, and a computing platform having a processor with a memory in communication with the processor. A map may be stored in the memory, and the map may have a node describing an object class. Map editor logic may be stored in the memory and executable by the processor. The map editor logic may be configured to receive input describing an event for object creation from the user, and the map editor logic may be configured to generate a map, stored in the memory, having a node having an object class that includes the data describing the event for object creation. The map editor logic may be configured to generate a business application, stored in the memory, having a Business Logic that exchanges data with an App Infrastructure, in which the Business Logic comprises some business rules and the map, and the App Infrastructure may include a computational element. Application processing logic may be stored in the memory and executable by the processor. The application processing logic may be configured to process the business application using the business rules of the Business Logic to generate an output, the output formed by processing the computational element of the App Infrastructure according to the business rules of the Business Logic. Display logic may be stored in the memory and executable by the processor, and the display logic configured to display the output on the display screen of the electronic device.

In further embodiments, the system may include a server in communication with the electronic device, and the server may be the computing platform.

In further embodiments, the computing platform may be a cloud computing platform, and the application processing logic may be processed via serverless functions.

In still further embodiments, the application processing logic may be processed via a type of serverless function that we define and name as abstract function.

In still further embodiments, the map may be stored as a text file.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A—FIG. 1A shows an illustrative example of some of the components and computer implemented methods which may be found in a system for development of visual business applications according to various embodiments described herein.

FIG. 1B—FIG. 1B shows a block diagram illustrating some applications of a system for development of visual business applications which may function as software rules engines according to various embodiments described herein.

FIG. 1C—FIG. 1C shows a block diagram with an example of a business application being executed in the Cloud, showing the inputs it receive and the output it produces, according to various embodiments described herein.

FIG. 2—FIG. 2 shows a graphical representation (called Map), of an example of a business application according to various embodiments described herein.

FIG. 3—FIG. 3 presents a block diagram of a method to create and maintain a map, according to various embodiments described herein.

FIG. 4—FIG. 4 displays a list of example objects, which may be used in an Enterprise Application Map, according to various embodiments described herein.

FIG. 5—FIG. 5 shows exemplary attributes of the exemplary objects shown in FIG. 4, according to various embodiments described herein.

FIG. 6—FIG. 6 shows an example method for transforming graphic elements of a map into compiled code according to various embodiments described herein.

FIG. 7—FIG. 7 shows an example of an execution sequence method, according to various embodiments described herein.

FIG. 8—FIG. 8 shows an example method for preparing input data before further processing, in the execution of an Enterprise Application, according to various embodiments described herein.

FIG. 9—FIG. 9 is an example to explain how the input files may be integrated to produce the data structure used in the Calculus of the Business Application, according to various embodiments described herein.

FIG. 10—FIG. 10 is an example to explain how Calculus iterate upon the data structure to produce the Enterprise Application results, according to various embodiments described herein.

FIG. 11—FIG. 11 is an example to explain how data may be grouped to produce the Enterprise Application results, according to various embodiments described herein.

FIG. 12—FIG. 12 is an example to explain how the object Calculus may add values to the data structure, according to various embodiments described herein.

FIG. 13—FIG. 13 is an example used to explain some of the operations the Table could provide, which is one of the Objects used in the Map, according to various embodiments described herein.

FIG. 14—FIG. 14 is an example used to explain how the Grouper may be defined, which is one of the Objects used in the Map, according to various embodiments described herein.

FIG. 15—FIG. 15 is an example of some blocks defined in the system, to define the Assembly or the Calculus displayed on the Map, according to various embodiments described herein.

FIG. 16—FIG. 16 shows an example of blocks usage as identified in FIG. 15, to define an object 430 Assembly, according to various embodiments described herein.

FIG. 17—FIG. 17 shows a sample usage of the blocks identified in FIG. 15, to define an Object Calculus 440, according to various embodiments described herein.

FIG. 18—FIG. 18 illustrates an example process of the system which may be used to automatically generate reduced versions of the Map of an Enterprise Application, according to various embodiments described herein.

FIG. 19—FIG. 19 is an example of a method which can be used to provide the necessary specifications which may be done to construct a new Map view according to various embodiments described herein.

FIG. 20—FIG. 20 shows an example of a process that may be used to define an Enterprise Application based, for these purposes, in the interactions that may be performed with the system matter of this request according to various embodiments described herein.

FIG. 21—FIG. 21 shows an example of some interactions that the system, matter of this request, may provide according to various embodiments described herein.

FIG. 22—FIG. 22 shows an example of how additional information may be added to the Map Nodes, to complete the Enterprise Applications documentation according to various embodiments described herein.

FIG. 23—FIG. 23 shows an example of how the system, matter of this application, may contain a big amount of Calculus Objects, each of them associated to nodes of a Map Node according to various embodiments described herein.

FIG. 24—FIG. 24 shows an example of how could the effect on FIG. 23 be obtained, but using only Calculus Objects according to various embodiments described herein.

FIG. 25—FIG. 25 shows an example of a block diagram of an electronic device, which may be used to perform some of the steps of the disclosed methods, according to various embodiments described herein.

FIG. 26—FIG. 26 shows an example of a block diagram of a server, which may be used to perform some of the steps of the disclosed methods, according to various embodiments described herein.

FIG. 27—FIG. 27 illustrates a block diagram of an example method of creating a business application as a graphical model, and then converting it into a text file that can be executed, according to various embodiments described herein.

FIG. 28—FIG. 28 depicts a block diagram of an example method of creating an abstract function according to various embodiments described herein.

FIG. 29—FIG. 29 show a block diagram of an example method of executing an abstract function according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### DEFINITIONS

As used herein, the term “computer” refers to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

It is understood that a business application may be a software solution used by a company to support the development of the business, to solve problems related to the execution of their business, to provide useful background in developing their business, and/or to support any other business-related activity within the company, etc. A business application can be built using different forms and using different technical approaches, such as using any programming language, spreadsheets, databases or any other mean that is suitable for this purpose, although this list is not exhaustive. Specialists, who understand the techniques required to build it, using any of the mechanisms described above or other, are usually in charge of developing business applications. However, most employees of the business generally do not have the knowledge required to understand these developments, and therefore most employees generally cannot modify business applications developed using the different technical approaches described above.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for development of visual business applications are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

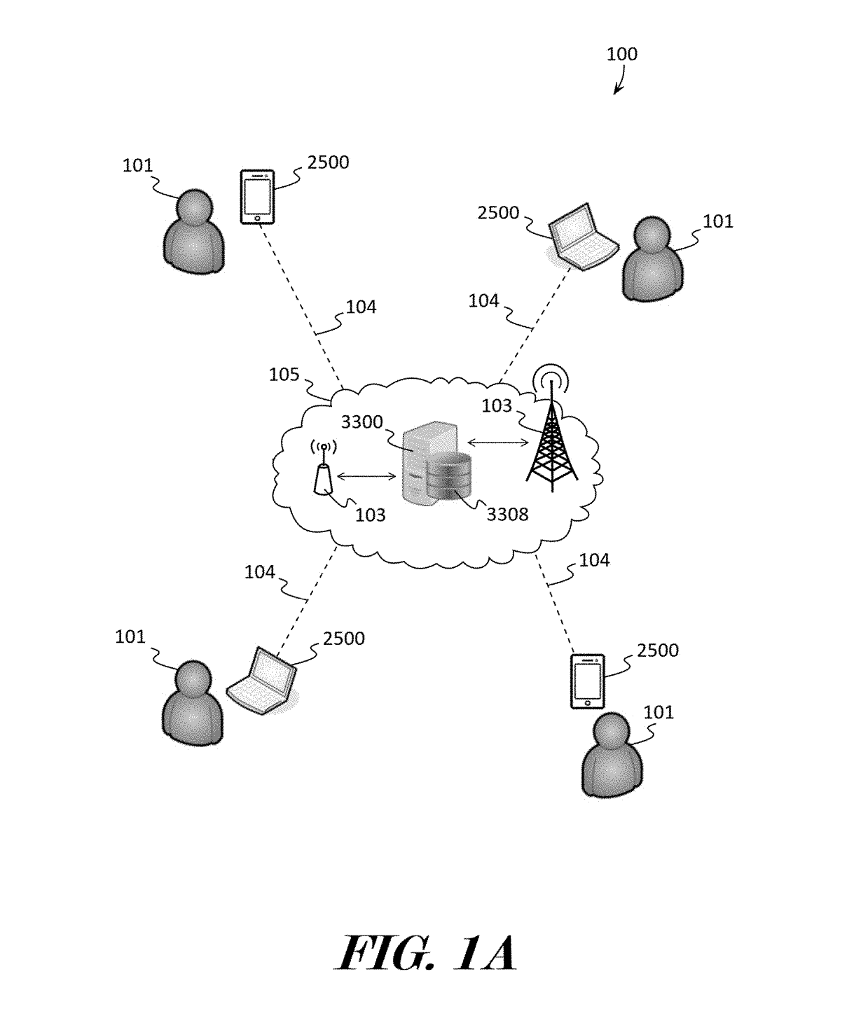

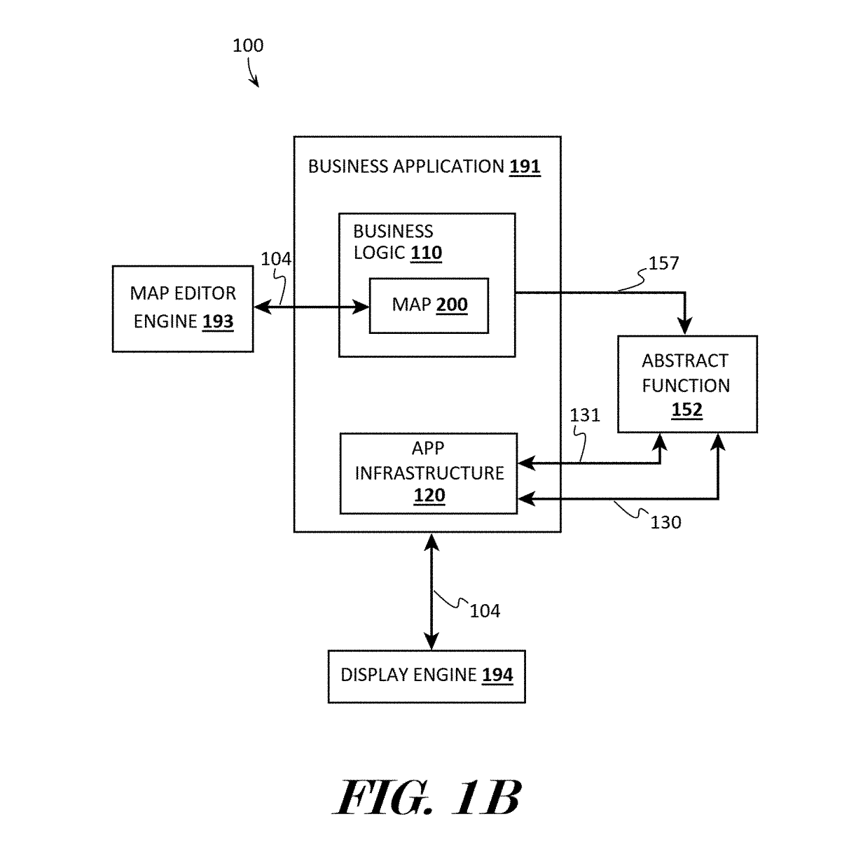

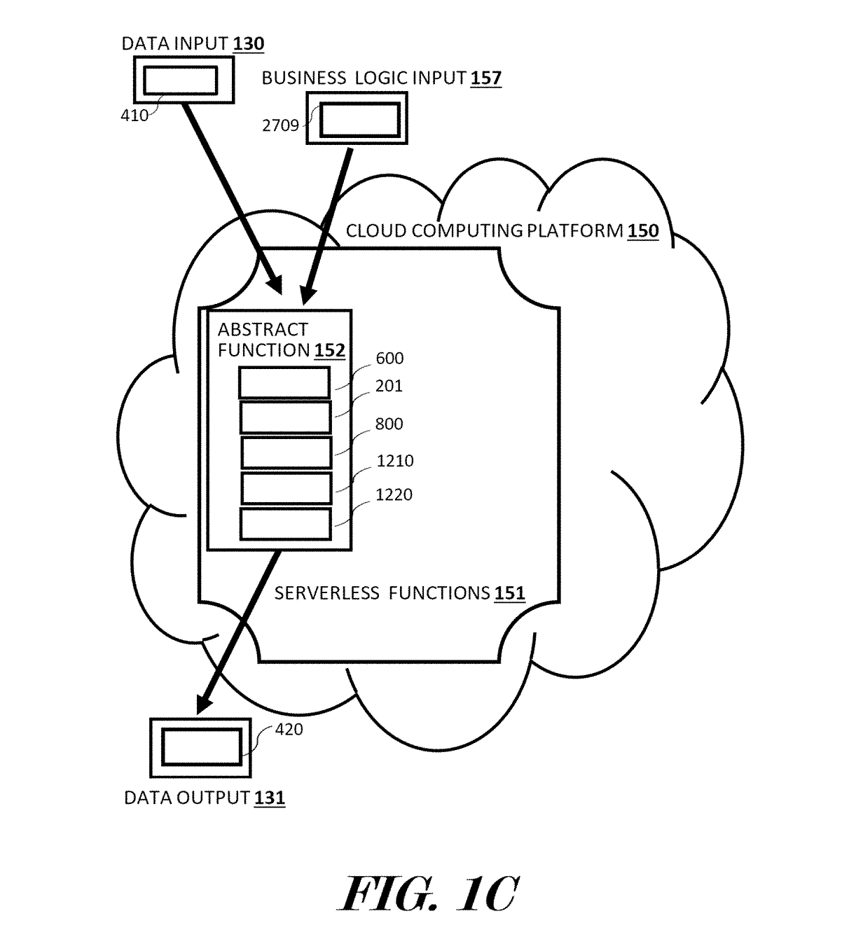

The method and system illustrated in FIGS. 1-26 of this document enable the building of business applications by segregating the business logic of the application and representing it in a way that, usually may be understood by generally any employee of the business, even those not having special technical knowledge.

In preferred embodiments, business applications may be developed using graphical elements such as, for example, mind maps, blocks, Tables Object 460 (also referred to as the “Structure of Boxes”) and others. The applications developed with these elements may be easier to understand than those that use other means such as programming languages, analytics tools as Excel, etc.

In preferred embodiments, the system and methods for development of visual business applications may contain documentation that is associated with each of the items shown in the above Map 200, and that can be developed in part automatically and can be compact and easy to understand.

In preferred embodiments, the system and methods for development of visual business applications are configured to allow a large application to be made using the graphical development approach described above instead of technical programming languages.

In preferred embodiments, the system and methods for development of visual business applications allows all business information of a business application to be analyzed, reviewed and presented in a graphic mode, according to specific needs, and therefore support the understanding of many specific aspects of the business application that might interest the user.

In preferred embodiments, the system and methods for development of visual business applications are able to reduce the effort to build business applications compared to conventional methods as described above.

The present invention will now be described by example and through referencing the appended figures representing preferred and alternative embodiments. As perhaps best shown by FIGS. 1A, 1B, and 1C, are illustrative examples of some of the physical components and software components which may comprise a system for development of visual business applications (“the system”) 100 according to some embodiments is presented. The system 100 is configured to facilitate the transfer of data and information between one or more access points 103, electronic devices 2500, and servers 3300 over a data network 105. Each electronic device 2500 may send data to and receive data from the data network 105 through a network connection 104 with an access point 103. A data store 3308 accessible by the server 3300 may contain one or more databases. The data may comprise any information pertinent to one or more business users 101 input into the system 100. In preferred embodiments, all relationships with users 101, devices 2500, communication facilities, data bases, deployment facilities, etc., are performed against the App Infrastructure 120, against the Map Editor Engine 193, and against the Display Engine 194. When the application is executed the Business Logic takes a veiled existence inside the Abstract Function 152, which previously was installed in the cloud. It is invoked by the App Infrastructure 120 which passes on the input data, a model in the form of text and which receives in return, the output data.

In this example, the system 100 comprises at least one electronic device 2500 (but preferably more than two electronic devices 2500) configured to be operated by one or more business users 101. Electronic devices 2500 can be mobile devices, such as laptops, tablet computers, personal digital assistants, smart phones, and the like, that are equipped with a wireless network interface capable of sending data to one or more servers 3300 with access to one or more data stores 3308 over a network 105 such as a wireless local area network (WLAN). Additionally, electronic devices 2500 can be fixed devices, such as desktops, workstations, and the like, that are equipped with a wireless or wired network interface capable of sending data to one or more servers 3300 with access to one or more data stores 308 over a wireless or wired local area network 105. The present invention may be implemented on at least one electronic device 2500 and/or server 3300 programmed to perform one or more of the steps described herein. In some embodiments, more than one electronic device 2500 and/or server 3300 may be used, with each being programmed to carry out one or more steps of a method or process described herein.

The system 100 may also comprise one or more software rules engines, such as an application processing engine 192, a map editor engine 193, and a display engine 194, which may optionally be configured to run on one or more servers 3300 and/or electronic devices 2500 that may be in communication with a system database according to various embodiments described herein are illustrated. The server 3300 and electronic device 2500 may be in wired and/or wireless electronic communication through a network 105 with a data store 3308 comprising a database, such as a system database. The engines 192, 193, 194, may read, write, or otherwise access data in one or more databases of the data store 3308. Additionally, the engines 192, 193, 194, may be in electronic communication so that data may be readily exchanged between the engines 192, 193, 194. It should be understood that the functions attributed to the engines 192, 193, 194, described herein are exemplary in nature, and that in alternative embodiments, any function attributed to any engine 192, 193, 194, may be performed by one or more other engines 192, 193, 194, or any other suitable processor logic.

A map editor engine 193 may comprise or function as map editor logic stored in a memory 3310, 2510, which may be executable by a processor 3302, 2502, of a server 3300 and/or electronic device 2500. In some embodiments, a map editor engine 193 may be configured to receive input describing an event for object creation from a business user 101. The map editor engine 193 may be configured to generate a map 200, stored in a memory 3310, 2510, having one or more nodes each having one or more object classes comprising the data describing the event for object creation. The map editor engine 193 may be configured to generate a business application 191, stored in the 3310, 2510, comprising a Business Logic 110 that exchanges data with a App Infrastructure 120, and the Business Logic 110 may comprise one or more business rules and the map 200, while the App Infrastructure 120 may comprise one or more computational elements. The map editor engine 193 may perform one or more functions as detailed below.

An application processing engine 192 may comprise or function as application processing logic stored in a memory 3310, 2510, which may be executable by a processor 3302, 2502, of a server 3300 and/or electronic device 2500. In some embodiments, an application processing engine 192 may be configured to process a business application 191 using one or more business rules of the Business Logic 110 to generate an output in which the output may be formed by processing the one or more computational elements of the App Infrastructure 120 according to the one or more business rules of the Business Logic 110. The application processing engine 192 may perform one or more functions as detailed below.

A display engine 194 may comprise or function as display logic stored in a memory 3310, 2510, which may be executable by a processor 3302, 2502, of a server 3300 and/or electronic device 2500. In some embodiments, a display engine 194 may be configured to display the output generated by one or more other engines 192, 193, on the display screen 2520A of an electronic device 2500 of a business user 101. In further embodiments, a display engine 194 may be configured to receive input from a business user 101 via an I/O interface 2520, such as a keyboard, mouse, touchscreen, etc., of their electronic device 2500 and to provide the input to the one or more other engines 192, 193.

In some embodiments, the system 100 may be configured to generate one or more business applications 191 via an application processing engine 192 and/or a map editor engine 193. Generally, a business application 191 may comprise software logic, which may be executed by an application processing engine 192, which may comprise a graphical model or map 200. The map 200 may be formed of graphical elements which may allow non-technical individuals, such as business users 101 to generate business applications without having to have programming language knowledge. In some embodiments, a business application 191 generated by the system 100 may include a Business Logic 110 that exchanges data with an App Infrastructure 120. The Business Logic 110 may include one or more business rules, and the App Infrastructure 120 may include all computational elements or data needed to generate and use the data exchanged with the Business Logic 110. Generally, the App Infrastructure 120 may contain data and the Business Logic 110 may contain business aspects, the application's 191 main aspects or the application's 191 decision rules, and/or what is technically known as “the business layer”, to allow the App Infrastructure 120 of the application 191 to be developed in conventional manner that might not be necessary to be understood by a business user 101. Generally, what has been called the Business Logic 110 of the application 191 may be the smallest part of the whole application 191 and preferably makes their development to be a minor part of the complete application development.

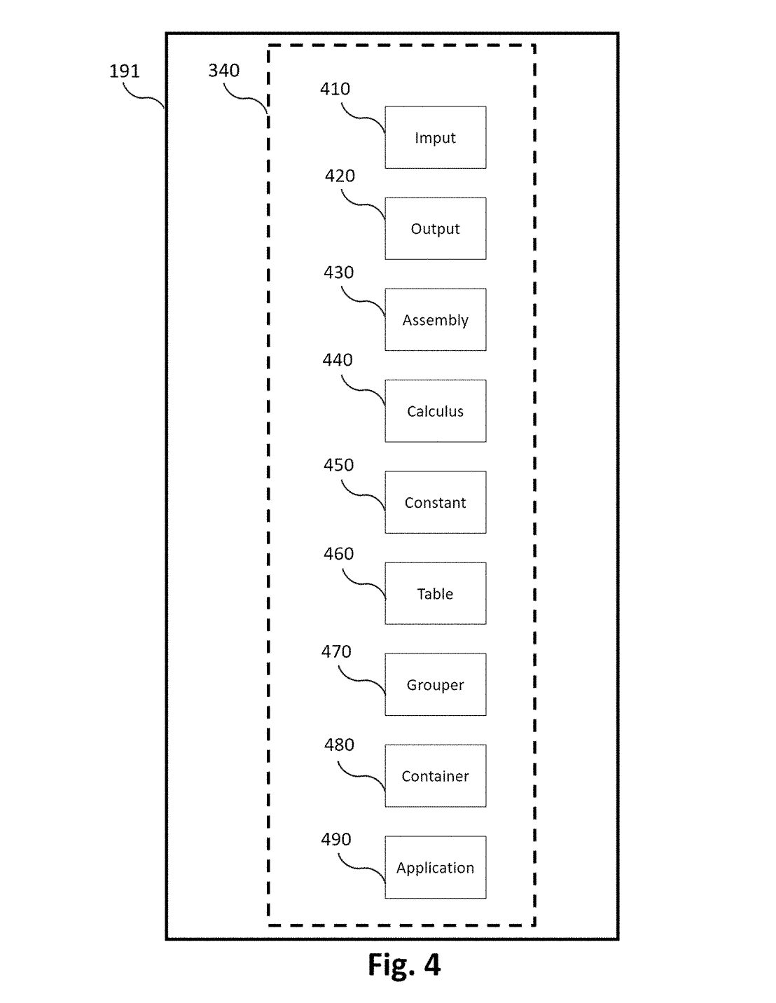

In preferred embodiments, a business application 191 may comprise one or more object classes 340 or classes of objects that allow representing the Business Logic 110 of the application 191 in a simpler way to understand. In further preferred embodiments and as shown in FIG. 4, a business application 191 may comprise object classes 340, such as Inputs 410, Outputs 420, Tables 460, Assemblies 430, Calculus 440, Constants 450, Containers 480, Groupers 470, and Applications 490. These objects of the object classes 340 are explained in the examples of FIG. 4.

In some embodiments, a Tables Object 460 (also referred to as the “Structure of Boxes”) can be characterized as groups of conditions associated with values. A Groupers Object 470 can be characterized because it gives a name to certain conditions that are used in the Business Logic 110 of the business application 191 and may have the properties of relying mainly on the input data, therefore it can be invariants of the business application 191.

### Examples of the System Architecture

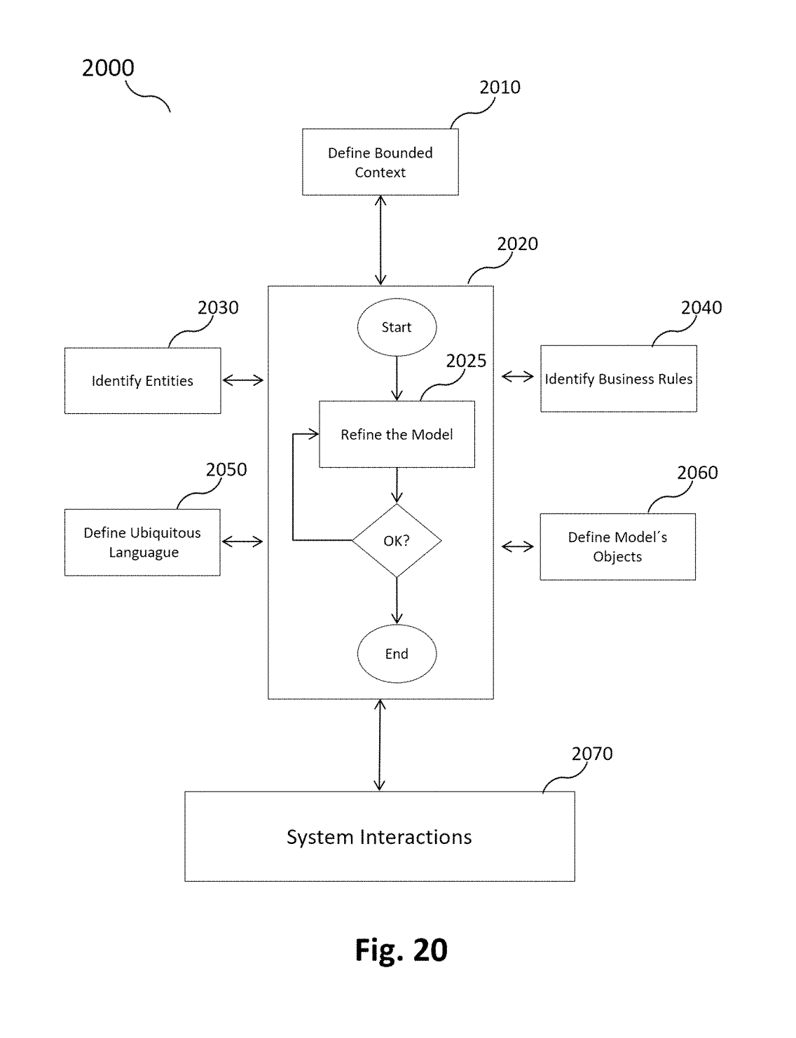

As shown in FIG. 1B, in some embodiments, a Business Application 191 may comprise two parts, a Business Logic 110 and a App Infrastructure 120. The Business Logic 110 may include a special capability to represent Business Rules, which are part of the process shown as example in FIG. 20. The App Infrastructure 120 of the Business Application 191 may contain additional computational elements, such as databases, software, file systems, etc., needed to provide the data required to process Business Rules, called Input 130, or to transfer the results generated by the Business Rules, called Output 131.

Data Input 130 and Data Output 131 may comprise, generally but not exclusively, data that may be added that corresponds to flat files in CSV format. Data transfer between the Business Logic 110 and the App Infrastructure 120 may be performed through any available computer mechanism in the enterprise infrastructure, such as asynchronous transfer files, Web Services, integration bus, etc.

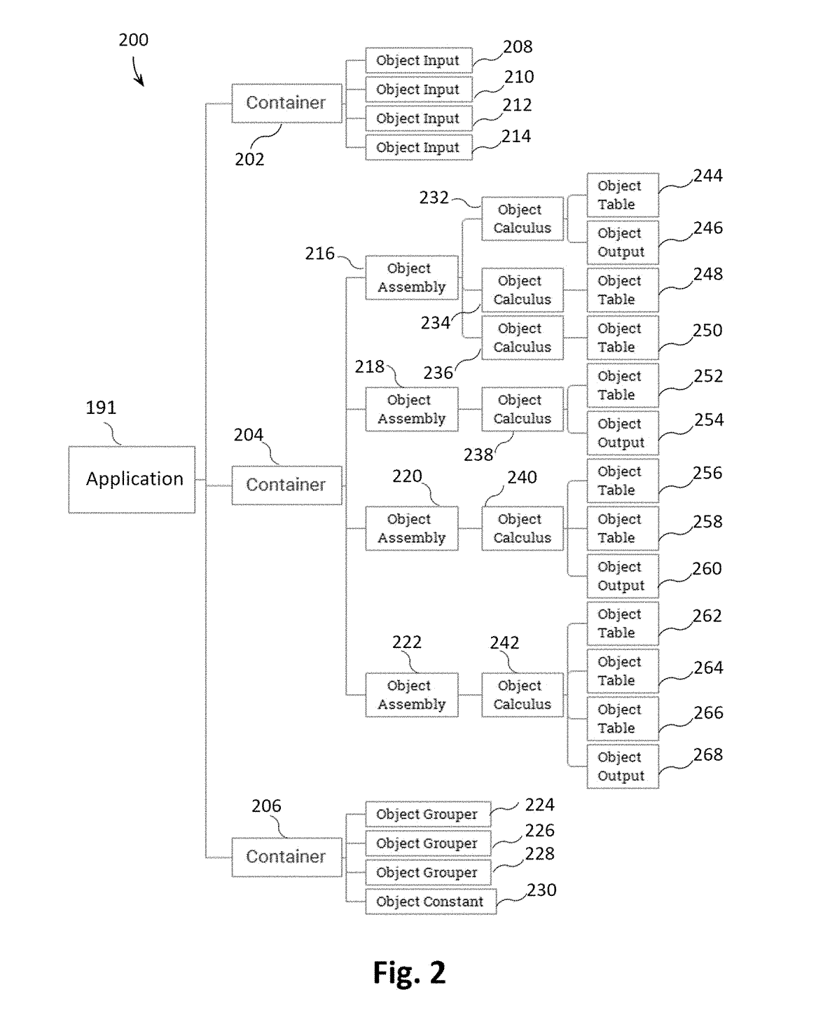

FIG. 2 shows a graphical representation of an example of a map 200 of a business application 191 according to various embodiments described herein. In FIG. 2, Map 200 is an example used for explanatory purposes of the methods of this system. In some embodiments, the map 200 may be a directed graph in which a parent may have multiple children, and a child may have several parents (does not have the restriction of a tree structure). Map nodes 202, 204, 206 . . . 268, show the object classes 340 that were used in the example of the Map 200, to represent Business Rules for that example. The object classes 340 are instances of nine exemplary classes provided by the system 100, that can increase or decrease quantity wise or as well become instances of different object classes 340.

FIG. 4 shows some exemplary object classes 340 according to various embodiments. Examples of object classes 340 may include: Input 410, Output 420, Assembly 430, Calculus 440, Constant 450, Table 460, Grouper 470, Container 480 and Application 490.

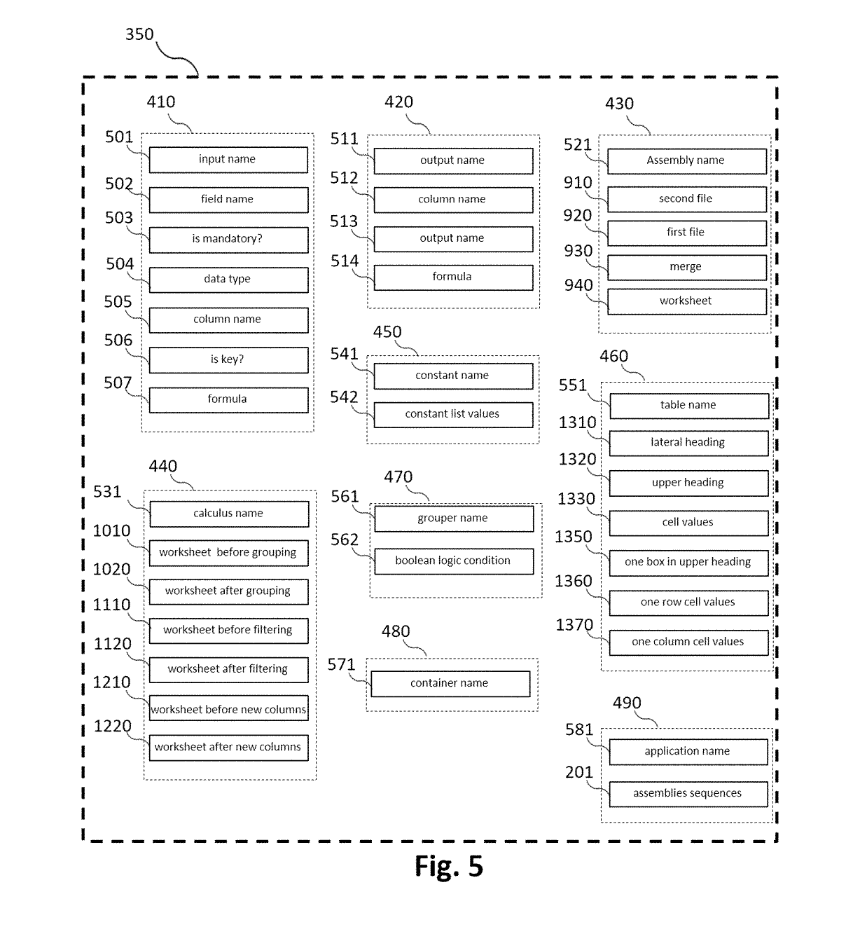

Input 410 may comprise data that may be used to define the data files or data records that may be received by the system. Some example attributes of objects of this class are shown in FIG. 5.

Output 420 may comprise data that may be used to define the files or records in which data calculated according to this system may be returned. Some example attributes of objects of this class are shown in FIG. 5.

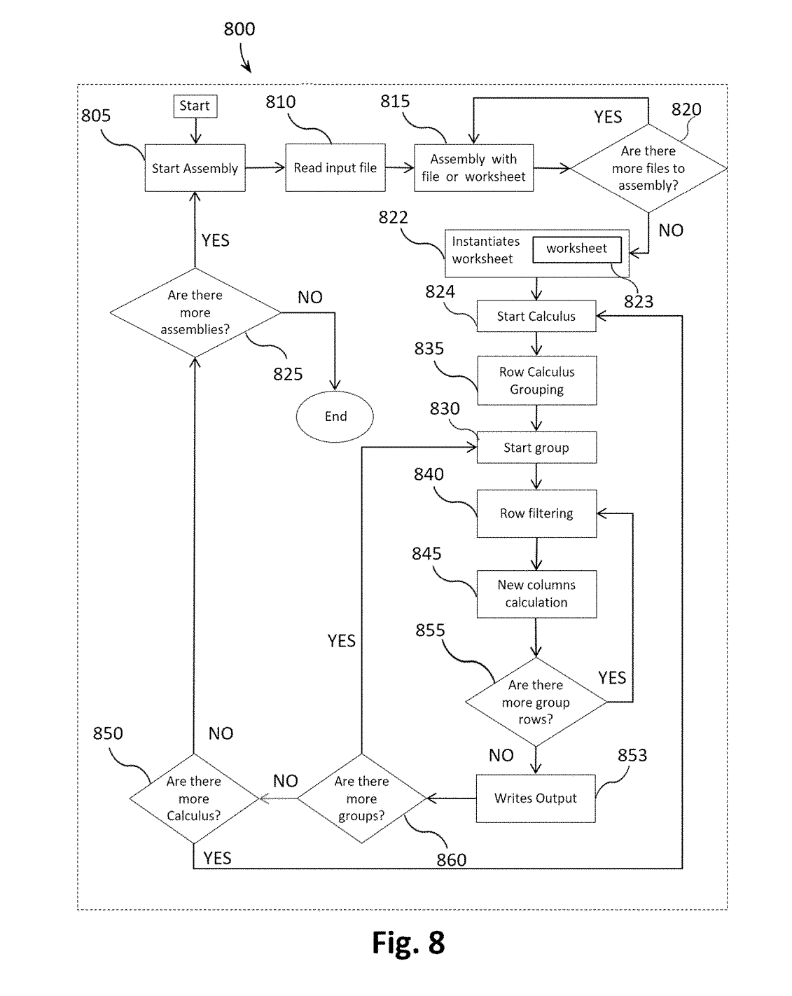

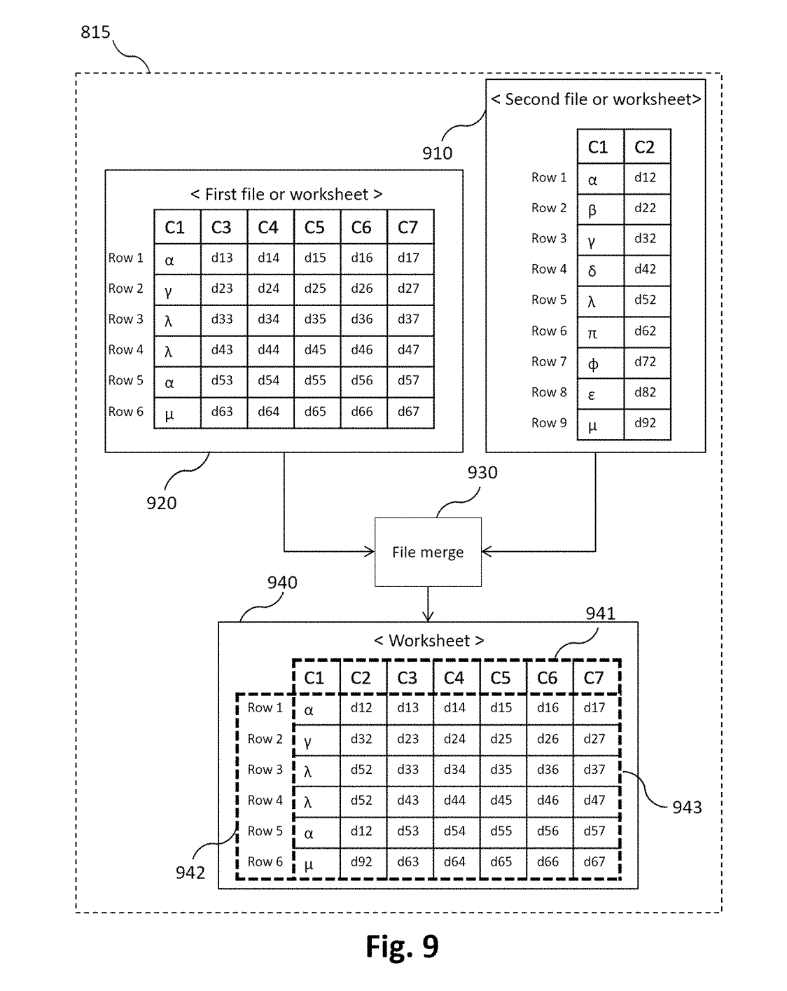

Assembly 430 may comprise data that may be used to define the integration processes for the information received as input. Flowchart of FIG. 8, is an example of the assembly process, that may be expressed by activities 805, 810, 815, 820. An example of a possible result of an assembly process is shown in FIG. 9, explained later.

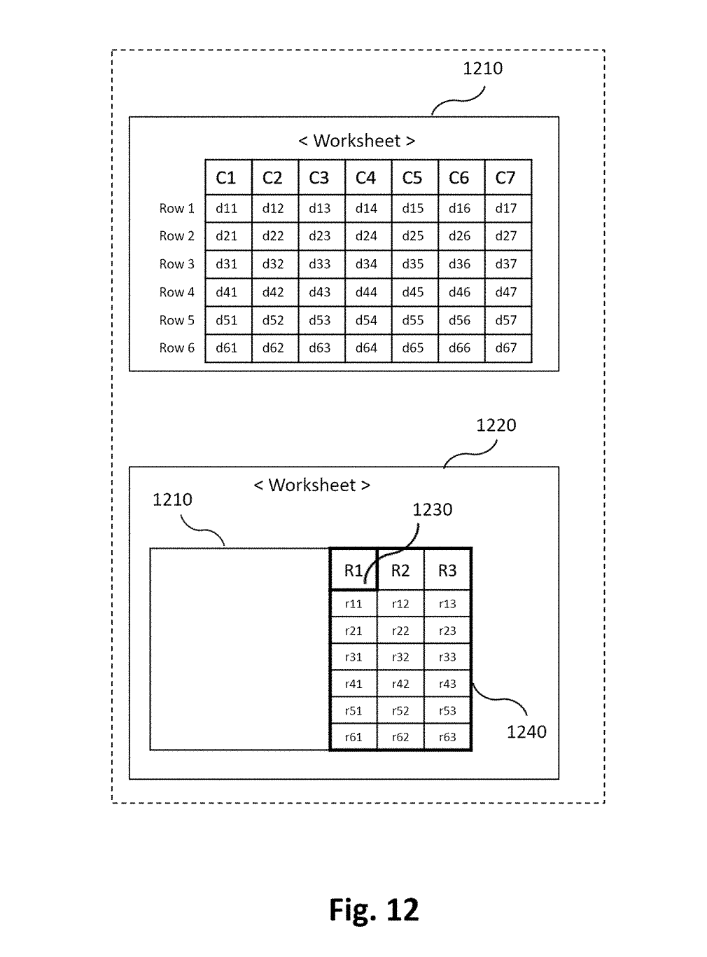

Calculus 440 may comprise data that may be used to define the generation of new values. Activities 830, 835, 840, 845, 850.855, 860 in Flowchart of FIG. 8, are an example of the process to generate new values. FIG. 12, which will be explained later, shows some possible examples of generated values.

Constant 450 may comprise data that may be used to define constants with similar characteristics as those used in traditional programming languages. A value assigned to a constant could be restricted to a set of possible values.

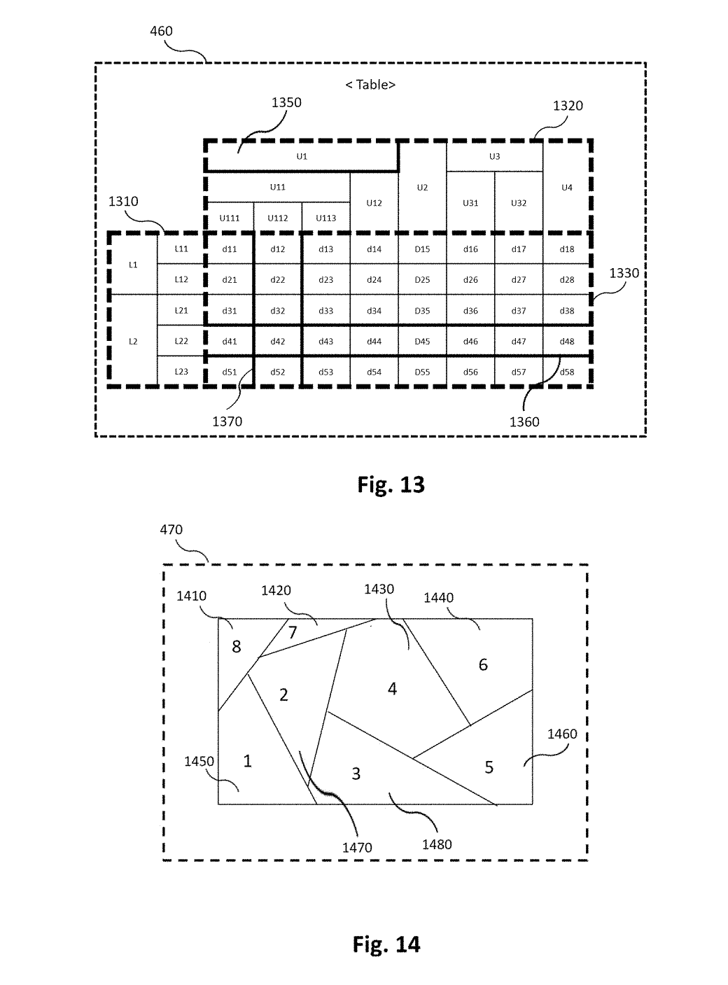

Table 460 may comprise data that may be used to bind conditions to values. A possible way, in which this binding is established, is shown by means of the example in FIG. 13, which approaches graphically the complexity of managing nested condition by using a “structure of boxes” that will be explained later.

Grouper 470 may comprise data that may be a Boolean object (its values are true or false) that may be used to identify grouping of input elements. Grouping that corresponds to names used within the Business Rules, e.g. “tropical fruits”, “winter fruits” of a certain type that receive different treatments within the Business Rules. They are characterized since the condition associated to them, depends only on input data and because in the Ubiquitous Language they are expressed as adjectives associated with the element on which the groups are defined. The specific way they may be defined is shown in a particular example discussed in FIG. 14.

Container 480 may comprise data that may be used to group other objects, and one of its attributes may be its name.

Application 490 may comprise data that may be used to define the order in which the Assembly 430 objects are executed. A possible attribute of the object Application 490, is the ordered list of names of the objects Assembly 430 objects that the application has.

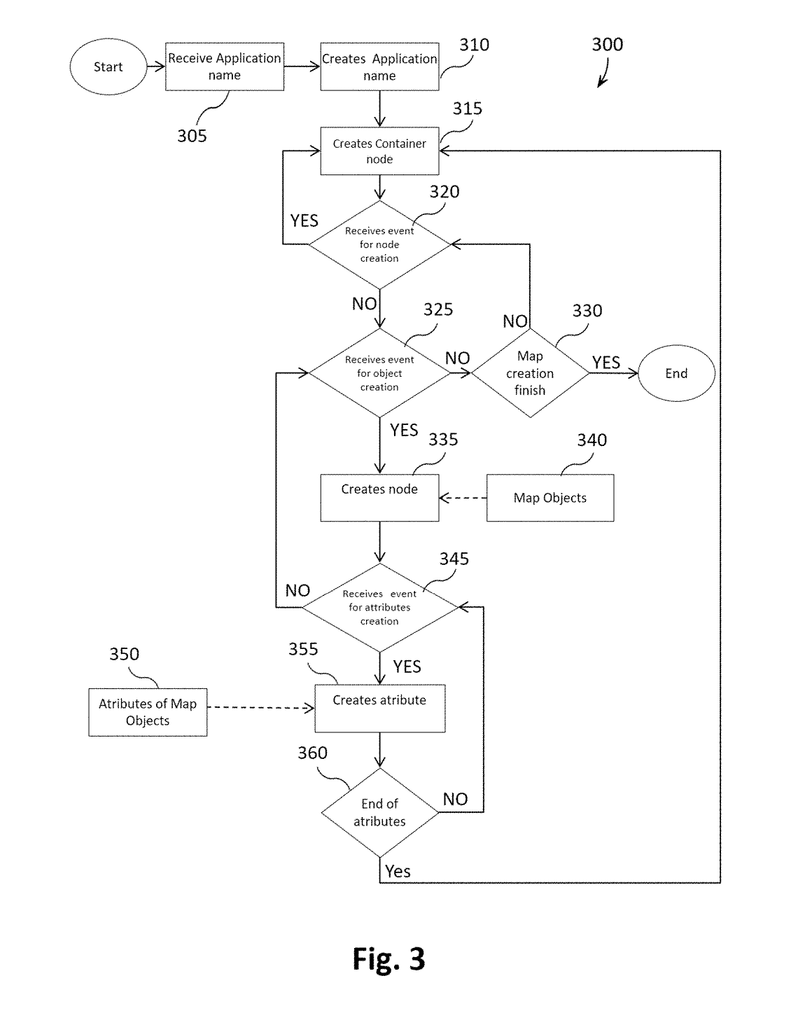

FIG. 3 shows a possible Flow Diagram of the map editor engine 193, which can be used to build and modify the Map 200. In some embodiments, the functioning of the map editor engine 193, may have a cycle for node creation, and may include steps 325, 335, 345, 355, 360. This cycle may be nested within another cycle for Containers nodes creation, which includes steps 315, 320, 360.

When a new map 200 is created, through the step 305, the map editor engine 193 may receive the application name, and thus creates the first node of the Map 200 in step 310, which may be associated with an object of Application type 490. Next, one or more Container nodes may be created in step 315, each of which can have a name attribute. Each node Container 480 may be associated with one or more nodes corresponding to object classes 340, such as for example, ones identified in FIG. 4. Each of the nodes added to the map 200 may be created, for example, with some of the attributes identified in FIG. 5. This may be done according to steps 345, 355, 360.

In decision block 320 the map editor engine 193 may determine if it has received data describing the event for the node creation. If this data is received, the data may be used in step 315. If the data is not received, the method 300 may proceed to decision block 325 and the map editor engine 193 may determine if it received data describing the event for object creation. If the data is not received, the map editor engine 193 may proceed to decision block 330 in which the map editor engine 193 may determine if the map creation is to finish. If the map creation is not finished, the method may proceed to step 320, and if the map creation is finished, the method 300 may end.

If the data is received in decision block 325, the map editor engine 193 may proceed to step 335 in which the map editor engine 193 may create the node using map objects such as those shown in FIG. 4. Next, the method 300 may proceed to decision block 345 in which the map editor engine 193 may determine if it received data describing the event for attributes creation. If it has not received the data, the method may proceed to block 325. If the data has been received the map editor engine 193 may create the attribute in step 355 using the attributes of the map objects returned in step 350. The method 300 may then proceed to decision block 360, and the map editor engine 193 may determine if there are any more attributes. If there are more attributes, the method 300 may continue to step 315. If there are more attributes, the method 300 may continue to decision block 315.

FIG. 5 shows exemplary attributes of the exemplary objects of the exemplary map 200 shown in FIG. 4, according to various embodiments described herein. This example is illustrative only and does not exhaustively cover all possible attributes that all objects may have. From a technical point of view, the attributes do not describe behaviors; therefore, FIG. 5 may show the intention of each attribute. There is no functionality associated with FIG. 5.

In the example of FIG. 5, Object Input 410 may have the following attributes:
501 Input name correspond to the name of the object Input;
502 field name, which is assigned to the 505 column
503 indication of whether the 502 field is mandatory or not;
504 data type of the 502 field, which can be numeric, text, Boolean or date;
505 column name, of each of the columns that has the Input;
506 indication of whether the 502 field is or is not, a key ID registration; and
507 formula, specifies a calculated value according to others 502 field name.

In the example of FIG. 5, Object Output 420 may have the following attributes:
511 output name, which is the name of Object output;
512 column name, internal name in the software of the invention as it appears in the Output worksheet FIG. 12 Box 1230;
513 Output name corresponds to the column name on the worksheet output; and
514 formula specifies a calculated value on the basis of other 512 column name;

In the example of FIG. 5, the Assembly 430 Object may have the following attributes:
521 Assembly name, which is the name of Object Assembly 910 second file that could correspond to the file that is added to the 920 first file as shown in FIG. 8 activities 805, 810, 815 and 820;
920 first file, that could correspond to the main file that controls the process as shown in FIG. 8 activities 805, 810, 815 and 820;
930 that could correspond to the process to merge or generate the internal calculation worksheet, from the 920 first file; and
940 worksheet, internal worksheet that is used by Calculus 440 to produce data that later appears in the Output 512 column name. Detailed explanation of the 940 worksheet will be delivered later.

In the example of FIG. 5, the Calculus 440 Object may have the following attributes:
531 Calculus name, which is the name of Object Calculus;
1010 worksheet before grouping, which may correspond to the 940 worksheet as it looks after the assembly process;
1020 worksheet after grouping, which may correspond to 1010 worksheet before grouping, as it is after the grouping process 835 row calculus grouping of FIG. 8;
1110 worksheet before filtering, which may correspond to each of the group's rows after 1020 worksheet grouping;
1120 worksheet after filtering, which may correspond to 1110 worksheet before filtering, as it is after the 840 row filtering process of FIG. 8;
1210 worksheet before new columns, may correspond to each of the rows of the 1120 worksheet after filtering; and
1220 after new worksheet columns, may correspond to the result of applying the Calculus to each of the rows of the 1210 worksheet before new columns.

In this process, as new columns are added values of these, may be considered in the calculation of the following columns. Calculating a column is specified for all data in that column in each of the rows of the worksheet, and is associated with the column headers such as box 1230 of FIG. 12.

In the example of FIG. 5, the Object Constant 450 may have only two attributes:
541 Constant name, corresponding to the Object name Constant; and
542 Constant list values, containing a finite or infinite set of values, one of which is chosen as the invariable constant value for the Enterprise Application Processing.

In the example of FIG. 5, the Object Table 460 may have the following attributes:
551 table name, which is the name of the Object Table:
1310 lateral heading, may correspond to a set of boxes that hierarchically grouped worksheet rows The hierarchy is constructed from right to left and is shown graphically as the size and relationship among the boxes as shown in box 1310 of FIG. 13;
1320 upper heading, may correspond to a set of boxes that hierarchically grouped worksheet columns. The hierarchy may be constructed bottom up and may be graphically displayed according to the size and relationship among the boxes as shown in box 1320 of FIG. 13;
1330 cell values, each of the 943 cells of a 940 worksheet on FIG. 9. The values of the 943 cells may be numbers, text or any type of data to be entered directly and are not affected by the Enterprise Application Processing;
1350 one box in the upper heading (Each of the boxes associated headers have a condition such as will be later explained);
1360 one row cell values, which are selected according to the conditions that are defined on the 1310 lateral heading; and
1370 one column cell values, which are selected according to the conditions that are defined in the 1320 upper heading.

In the example of FIG. 5, the Object Grouper 470 may have two attributes:
561 Grouper name, that corresponds to the name of the object Grouper; and
562 Boolean logic condition, containing a Boolean expression based solely on data from files Input 410. This condition does not have restrictions on the input data or concerning the complexity of itself.

In the example of FIG. 5, the Object Container 480 may have one attribute; 571 container name corresponding to the name of the Object Container.

In the example of FIG. 5, the Object Application 490 may have two attributes:
581 application name corresponding to the name of the Object Application; and
201 assembly sequence(s) corresponding to an ordered list according to which are executed different Assemblies 430 defined on the Map.

FIG. 9 is an example to explain how the input files may be integrated to produce the data structure used in the Calculus of the business application 191, according to various embodiments. Worksheet 940 is an example of the internal structure that can be used throughout the processing of the business application 191. Optionally, worksheet 940 may comprise an object not present in the Map 200. The structure of the worksheet 940 may be similar to a spreadsheet. The columns 941 may have an assigned name heading. In some embodiments, associated to the column name exists a formula that is part of a Calculus, which allows to assign values to each of the cells in the column. Rows 942 may have no header and may contain the values that appear in cells 943. Cells 943 may contain pure values that have no associated names or formulas, and can be of any data type, numeric or text.

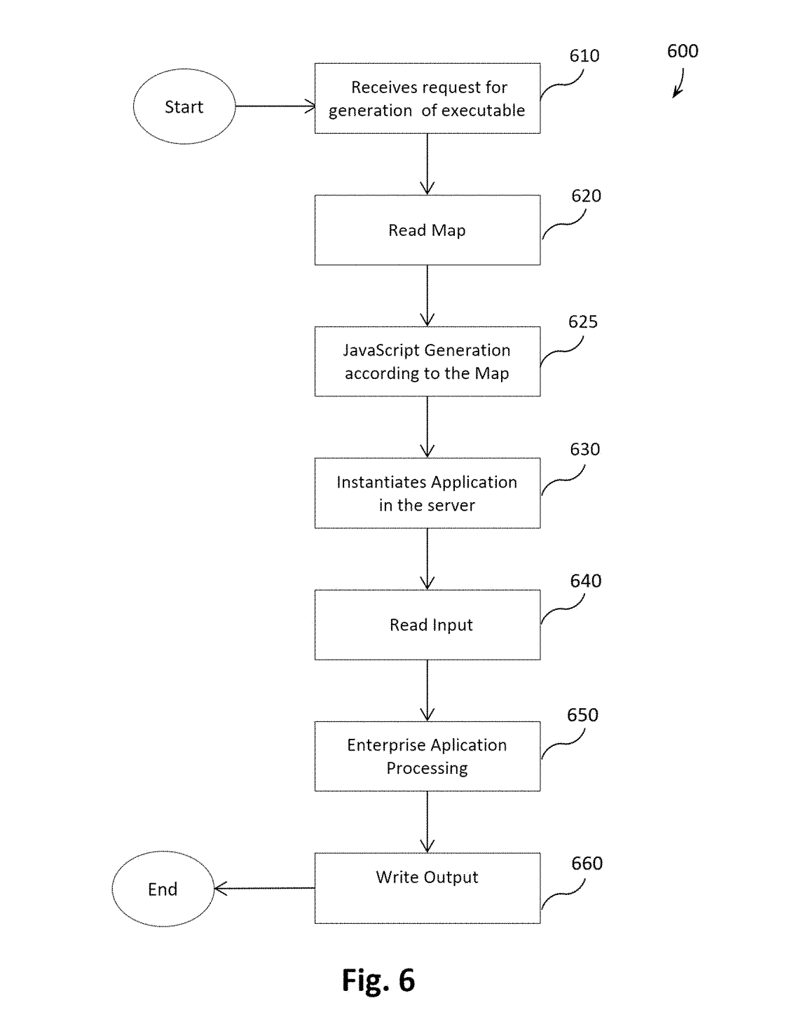

FIG. 6, shows the process through which the graphic elements of a Map 200 may be transformed into compiled code by the application processing engine 192. By using this code, it is ensured that the business application 191 will run as it appears in the latest version of the Map 200. This process precedes the one described in FIG. 8, which is responsible for producing the expected results of the business application 191.

FIG. 6 shows an example method for transforming graphic elements of a map into compiled code according to various embodiments described herein. The steps of the method 600 may be performed by an application processing engine 192. In some embodiments, the method 600 may start and in step 610 the application processing engine 192 may receive a request for generation of executable. This may be an event that begins the generation or creation of a business application 191. In step 620 the application processing engine 192 may Read the Map 200 to review the database in which Map 200 specifications are stored. This review is made following a guideline that can take into account the location of the nodes on the Map 200, as their attributes. In step 625 the application processing engine 192 may generate JavaScript according to the data in the Map 200 by interpreting data read in step 620 by a syntactic lexical analysis such as that performed by the compilers. The result could be the complete Enterprise Application expressed in JavaScript or in other programming language. In step 630 the application processing engine 192 may instantiate the server application. This may include a chain of utilities provided by the operating systems for these purposes. In step 640 the application processing engine 192 may read input. In step 650 the application processing engine 192 may process the input form step 604 and write output in step 660. The write outputs of step 660 referring to files transfer between the Business Logic 110 and the App Infrastructure 120. The application processing engine 192 may aggregate data files generally, but not exclusively, corresponding to flat files in CSV format.

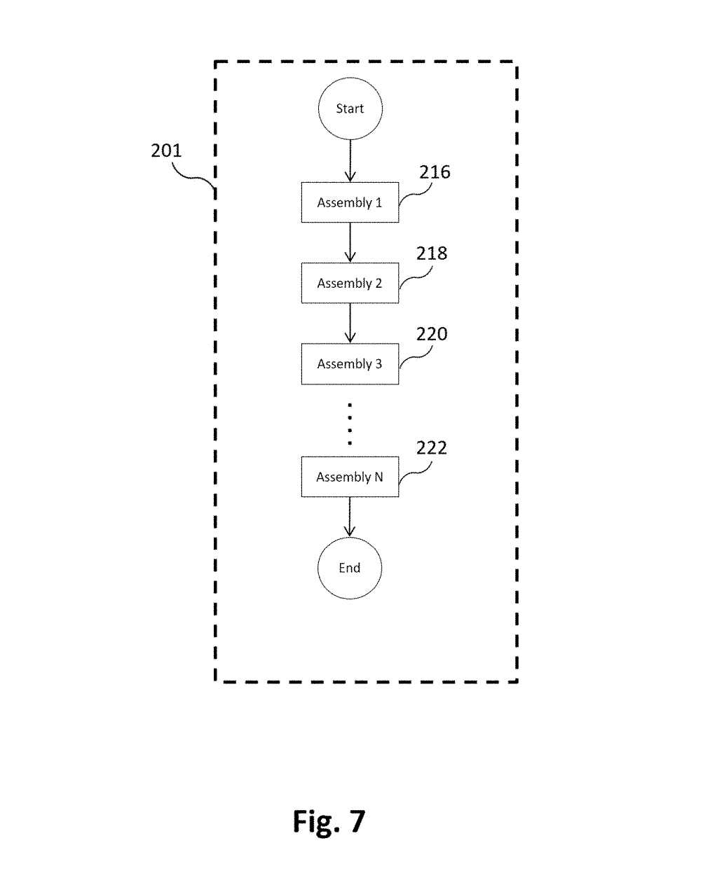

FIG. 7 shows an example of an assembly sequence 201 that the Business Application 191 may execute. The sequence of execution follows the order of the Assemblies 216, 218, 220, 222, that are part of the Map 200. Generally, the assemblies 216, 218, 220, 222, of the map 200 may be processed by the Business Application 191.

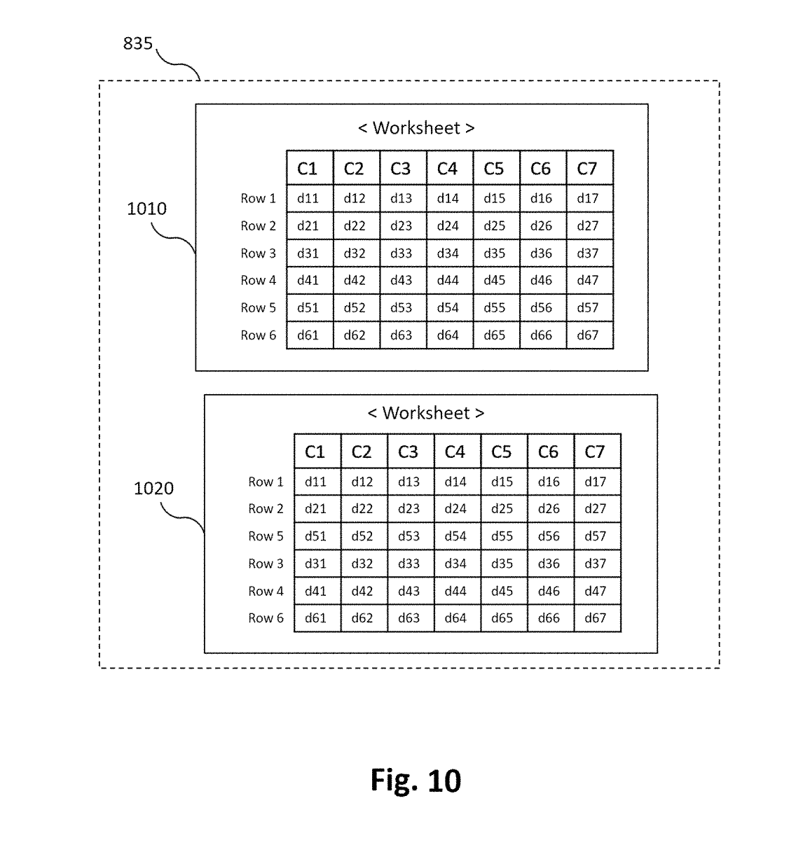

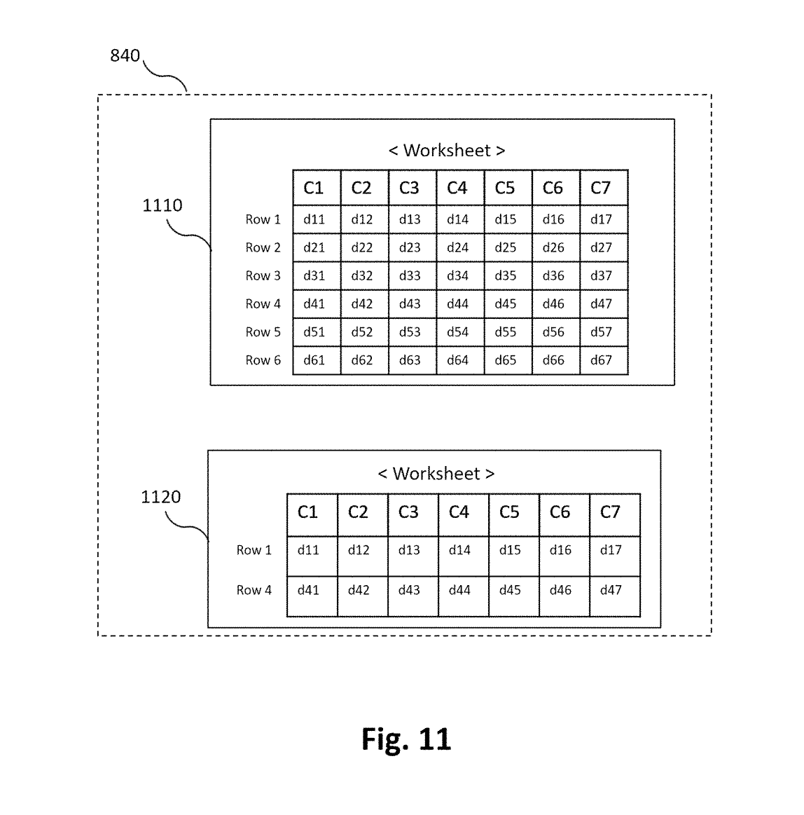

FIG. 8, shows an example of a method for business application 191 (Enterprise Application) processing by the application processing engine 192 (“the method 800”). The method 800 may be used for Mapping objects in the execution of a business application 191 by an application processing engine 192. The method 800 may start and Activities 805 “Start Assembly”, in step 810 the application processing engine 192 may “Read Input file”, in step 815 the business application 191 may “Assembly with file or worksheet”, in decision block 820 the application processing engine 192 may determine “Are there more files to assembly”?, in step 822 the application processing engine 192 may “instantiates worksheet” and in decision block 825 the application processing engine 192 may determine “Are there more Assemblies?, may be a way to execute all the 430 Assemblies defined in the Map. A possible detail of Activity 815 “assembly with file or worksheet” is shown in FIG. 9. In step 824 the application processing engine 192 may “start Calculus”, in step 835 the application processing engine 192 may “Row Grouping Calculus” and in decision block 850 the application processing engine 192 may determine “are there more Calculus” that may be an example of a possible cycle to process all Calculus associated with the same Assembly. In step 830 the application processing engine 192 may “Start Group”, in step 840 the application processing engine 192 may “Row filtering”, in step 845 the application processing engine 192 may “New column calculation”, in decision block 855 the application processing engine 192 may determine “Are there more group rows” and in step 853 the application processing engine 192 may “Write Output”. This may be an example of a possible process of each of the groups that are generated for a given Calculus. Activities in FIG. 8 may be focused to process data of Input 130, while the activity 853 may generate the Output 131. A possible detail of Activity 835 “row Calculus grouping”, is shown in FIG. 10. A possible detail of Activity 840 “row filtering”, is shown in FIG. 11. A possible detail of Activity 845 “New columns calculation”, is shown in FIG. 12.

FIG. 9 shows a possible example of activity 815 “Assembly with file or worksheet” that the application processing engine 192 may perform. Boxes 920 and 910 represent possible examples of input files Input 410. They may also be a 940 worksheet that may previously be produced in another 440 Assembly process.

A way to associate files may be declaring a column in each file as a value match column. In this case, the C1 in 910 “second file” and C1 of the 920 “first file” have their values represented by Greek letters. In row 920 “first file” C1 may have repeated values, but in C1 of 910 “second file” may not have repeated values. If there were repeated values 910 “second file” may consider the row associated to the first repeated value. A possible example of information integration process 930 “File Merge” is shown in the 940 worksheet, which has both columns of input files for those rows that have been associated as off the values of the C1 910 “second file” and the C1 920 “first file”. The resulting 940 “worksheet” includes C2 of 910 “second file” that does not exist 920 “first file”.

In FIG. 10, an example of activity 835 “Row Calculus Grouping” is shown. In this example, If d11=d21=d51 and d31=d41=d61, the calculation may be done grouped by C1, case in which the rows of the worksheet 1020 can be in the order: Row 1, Row 2, Row 5, Row 3 Row 4, Row 6. Calculus applied to this worksheet, as shown in the activities 830, 840, 845, 853 and 860 of FIG. 8, can be performed in two groups, the first group could be formed by Row 1, Row 2, Row 5 and the second group could be formed by Row 3 Row 4, Row 6. In these cases there may be aggregated operations such as adding the values of the column C5, which could perform the addition d15+d25+d55 and then could perform the addition d35+d45+d65.

Other group operations can be group average, group highest value, and group lowest value. The processing may be done group by group and may conclude when every row of the worksheet is processed.

In FIG. 11, an example of activity 840 “row filtering” is shown. It could be stated that some rows may be included or excluded in the Calculus. For example, it might be specified: “filter when C1=d11 or C1=d41, case in which the resulting worksheet 1120 may have 2 rows, for example Row 1 and Row 4.

In FIG. 12, an example of activity 845 “new columns calculation” is shown. Calculus may be executed from left to right, and the result r11 may be calculated using some of the d11, d12, . . . d17 data. The result r12 may be calculated using some of the data r11 and d11, d12 . . . d17. The result r13 may be calculated using some of the data, r11, r12 and d11, d12 . . . d17. Row 2, row 3, row 4, row 5, row 6, may follow the same previous pattern. The processing of this worksheet could be made row by row sequentially.

In FIG. 13, an example of the Object Table 460 (also referred to as the “Structure of Boxes”) is shown. It has the same characteristics of the Map 200 and of the Blocks which are resolved in a graphical model the representation of the complex and nested conditions in an easy to understand format as opposed to the Excel solution as well as that of programming languages which are complex and hard to understand. In this example, the structure of Table 460 may comprise three main parts, the 1330 cells, 1320 upper heading and 1310 lateral heading. The 1330 cells may contain pure values that could not have an associated name or formula, and could be any data type, numeric, text, Boolean, etc. The 1320 boxes of “upper heading” and 1310 boxes of “lateral heading”, can only have associated a Boolean value as well as an associated label. For example, the 1350 box could be called “tropical fruit” and the condition associated with the same box could be Name=Mango OR name=Pineapple OR name=Banana.

Condition to select one column may be done applying the “AND” operator upon the conditions associated to each of the boxes piled on top of the column. For example: 1370 column is selected when condition U1=True AND condition U11=True AND condition U112=True. Condition to select one row may be done applying the “AND” operator upon the conditions associated to each of the boxes piled to the left of the row. The associated value to cell d42 can be returned when Table 460 is used having column 1370 and row 1360 are selected.

In FIG. 14, an example of a set of Groupers 470 is shown. In this case each of the Groupers may be defined upon the values of an Input 410 field called “fruit name”. In this example the set of Groupers 470 comprise eight groupers, each of which may have a unique name. Each of the Groupers may be defined by sets of values within a universe of possible values. The Grouper 1450 comprises the values “banana, pineapple, mango” and the Grouper 1470 comprises the values “blackberry, raspberry, strawberry”. The Grouper 1450 name may be “IsTropicalFruit” and the Grouper 1470 name may be “IsBerrie”. Each of them is a Grouper having a “true” or “false” value. When a record of the file Input is read, the value of “name of a fruit” with each Groupers associated with that field values are compared. Only one of them may be true and the rest may be false The Groupers in the set of Groupers 470 may be used as conditions associated to the headings of the Object Table and also could be used in the Object Calculus.

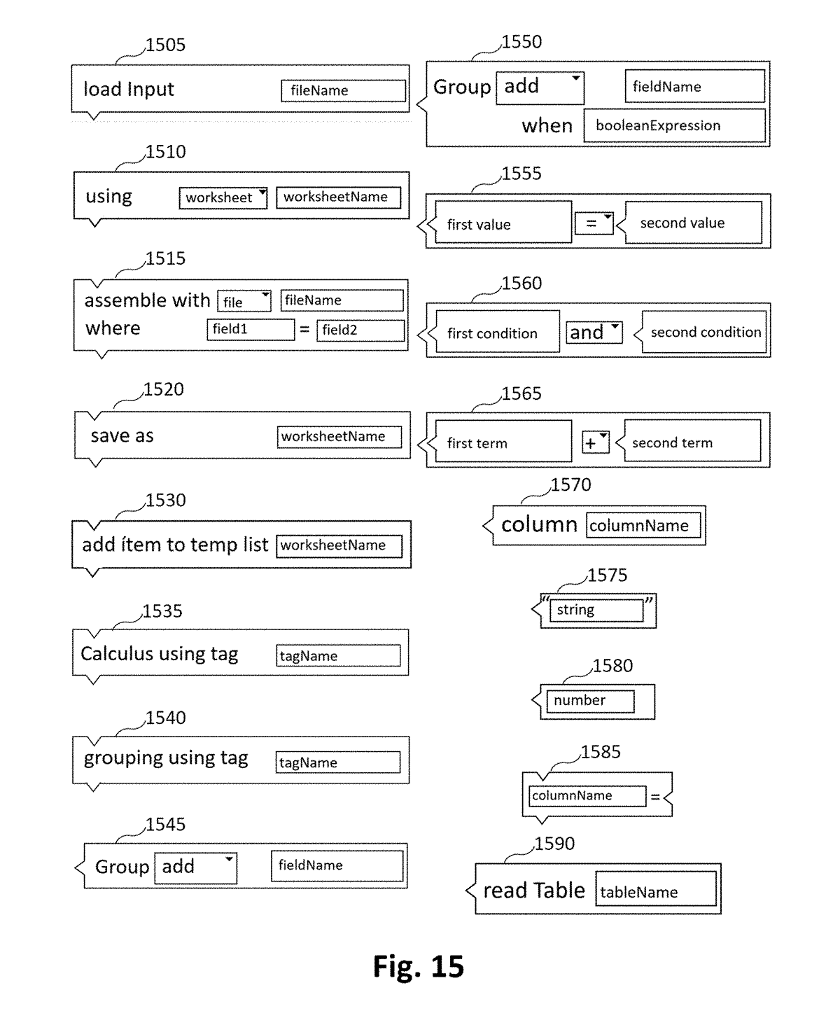

In FIG. 15, an example of the blocks used in the system 100 to edit (create or modify) the Objects Assembly 430 and Calculus 440 is shown. The general operation of the blocks is defined in the Blockly's Google platform. Blockly is an example of the technology used by the system, although other similar graphic platforms may be used. Blockly specification is available on the site https://developers.google.com/blockly/. What follows are some examples of additional blocks that could be required by the system.
Block 1505 may be used to specify the first file involved in an Object Assembly, as exemplified in FIG. 9.
Block 1510 may be used to specify a Worksheet as the first element of an Object

Assembly.
In any of the above two cases, the block 1515 may be used to specify the second element of an Object Assembly, as exemplified in FIG. 9. The second element can be either an Object Input 410 or a Worksheet. In block 1515, the name “field1” and the name “field2”, of the first and second element above referenced, may be used as a key to produce the match between the rows of the two elements of the Object Assembly.
Block 1520 may be used to specify the name of the Worksheet that is created in the Assembly, as exemplified in FIG. 9.
Block 1530 may be used to create an additional Worksheet, and Object Calculus 440 may create each row of that additional Worksheet.
Block 1535 may be used to invoke processing the Calculus that have the same value tag (the tag is a tag that can be associated to Calculus).
Block 1540 may be used to control the evaluation of the Object Groupers, based on the values of the Object Inputs fields.
Block 1545 is used to specify aggregated operations, where aggregated operations are values associated to all rows of the same group (FIG. 10 shows an example of grouping rows). Block 1545 is an example for the addition of the values of “fieldName” for every row of the same group. Other aggregated operations can be average, maximum value, minimum value and counting.
Block 1550 can be used for the same purposes as the block 1545, but may allow selection amongst all the rows, only those that meet the WHEN condition specified in the same block.
Block 1555 is a standard Blockly block used for comparisons.
Block 1560 is a standard Blockly block used for Boolean operations (to compose conditions).
Block 1565 is a standard Blockly block used to do arithmetic operations between two terms.
Block 1570 may be used to read column values of the Worksheet.
Block 1575 is a standard Blockly block used to assign a value of a string type.
Block 1580 is a standard Blockly block used to assign a numeric value.
Block 1585 may be used to assign a value to a new column in the Worksheet.
Block 1590 may be used to obtain the value of a cell from an Object Table.

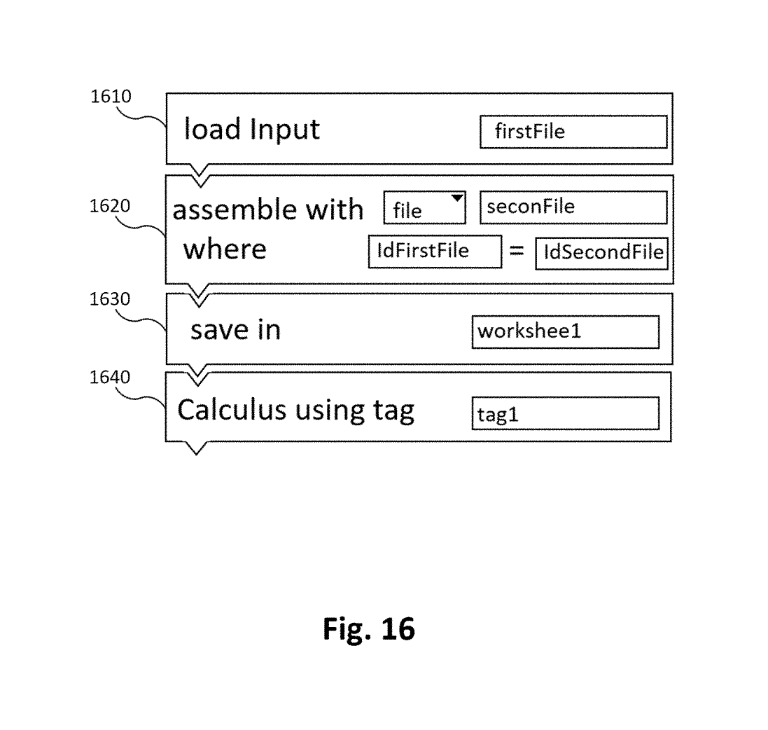

FIG. 16 shows an example of the use of blocks explained in FIG. 15, to define an object Assembly 430.
Block 1505 may read and load an Object Input 410, which in this case may be named “first file”.
Block 1515 may read a second Object Input 410, this time may be called “secondFile” and may declare that the match keys are file1 for the first file and file2 for the second file.
Block 1520 may declare that the Worksheet name that is created in this Assembly is “worksheetName”.
Block 1535 may specify that Object Calculus 440 that is executed associated to the Assembly in FIG. 16, are those with a tag with the value “tagName”.

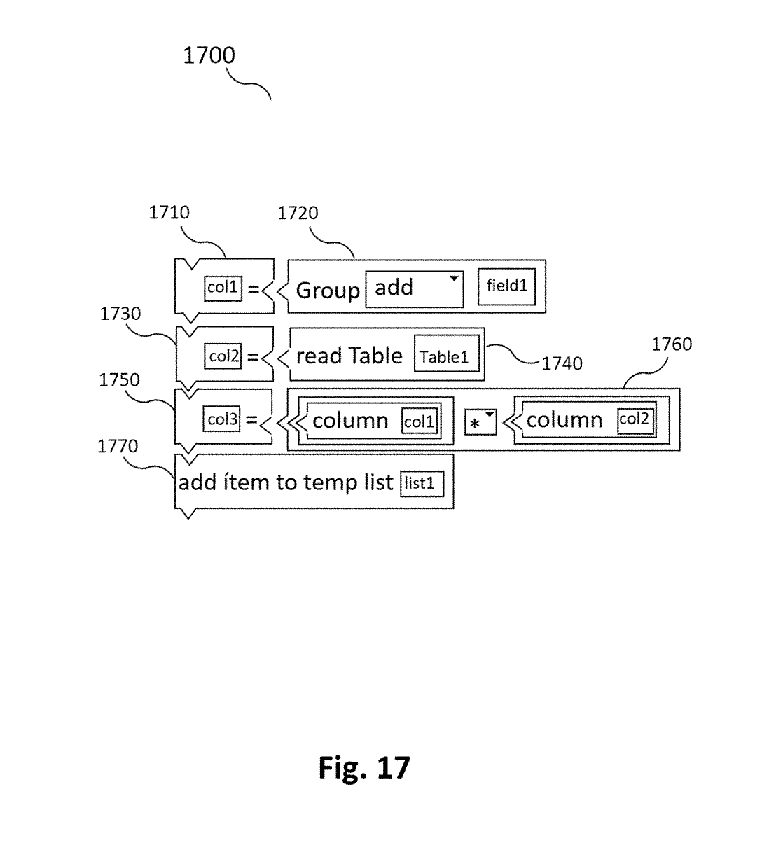

FIG. 17 shows an example of how blocks explained in FIG. 15, may be used to define an object Calculus 440.
Blocks 1585-1, 1585-2 and 1585-3 are different instances of the block 1585.
Blocks 1585-1, 1585-2 and 1585-3 may create columns named “col1”, “col2” and “col3” respectively.
Block 1545 may assign to col1 the addition of field values “field1”, for all rows in the same group.
Block 1590 may assign to col2 the value obtained by reading the Object Table 460, named “Table1”, for all rows in the same group.
Block 1565 may assign to co13 the result of multiplying col1*col2.
Blocks 1530 may state that these results will be stored in a different Worksheet than the standard Worksheet, called “list 1”. The standard Worksheet may be associated to the Systems Object Assembly.

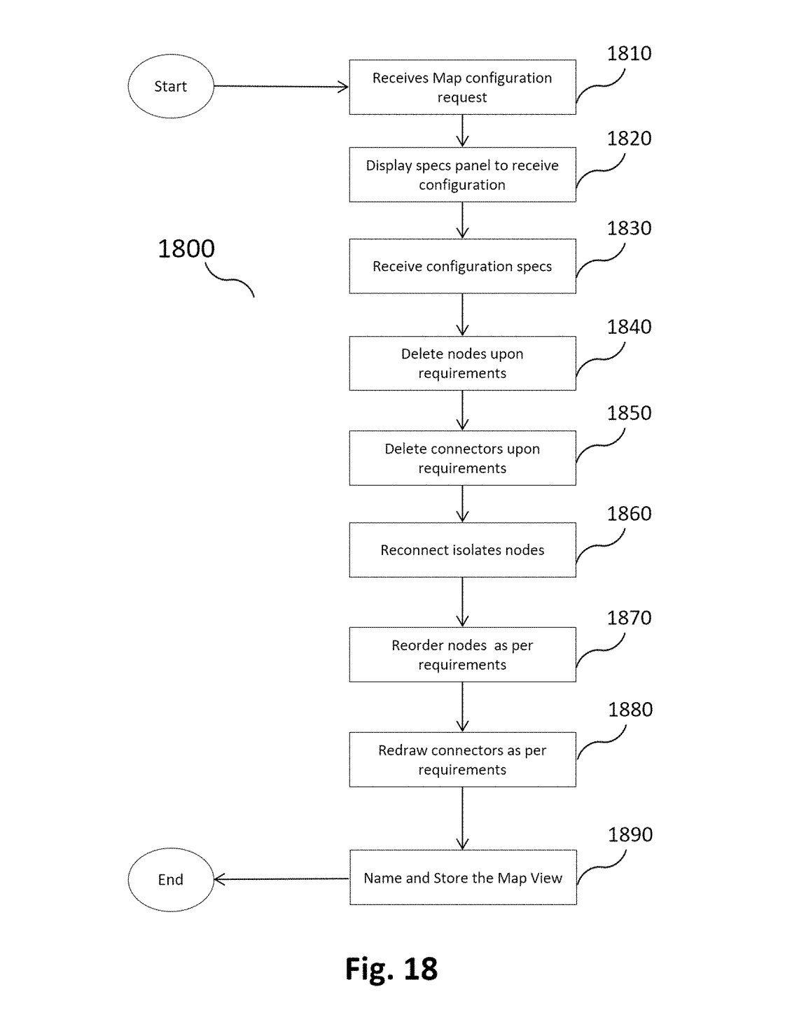

FIG. 18 shows a possible example of the process applied to the Map 200 to selectively generate different specialized views. These views may enable to focus on some specific aspects of the Map 200 that are suitable for analysis or understanding the Business Application model. This process may comprise the following activities:
Activity 1810 “receive map reconfiguration request”, may start the process to generate a new view.
Activity 1820 “display specs panel to receive configuration”, may expose an interface that may be used to express any criteria that could be used to add or reduce nodes and/or connectors between nodes in the Map.
Activity 1830 “receive configuration specs”, may be used to receive criteria that could be used to add or reduce nodes and/or connectors between nodes in the Map.
Activity 1840 “Delete nodes upon requirements”, may apply criteria to remove nodes that may not be needed in the new view.
Activity 1850 “delete connectors upon requirements”, may remove connectors between nodes that may not be needed in the new view.
Activity 1860 “reconnect isolated nodes”, may be the process by which nodes becoming disconnected in the Map (remain isolated), as a result of the above criteria application. The appropriate reconnection strategy may be chosen for the new view, based on above criteria.
Activity 1870 “reorder nodes as per requirements”, may receive additional distribution criteria.
Activity 1880 “redraw connectors as per requirements”, may receive additional connectors styles.

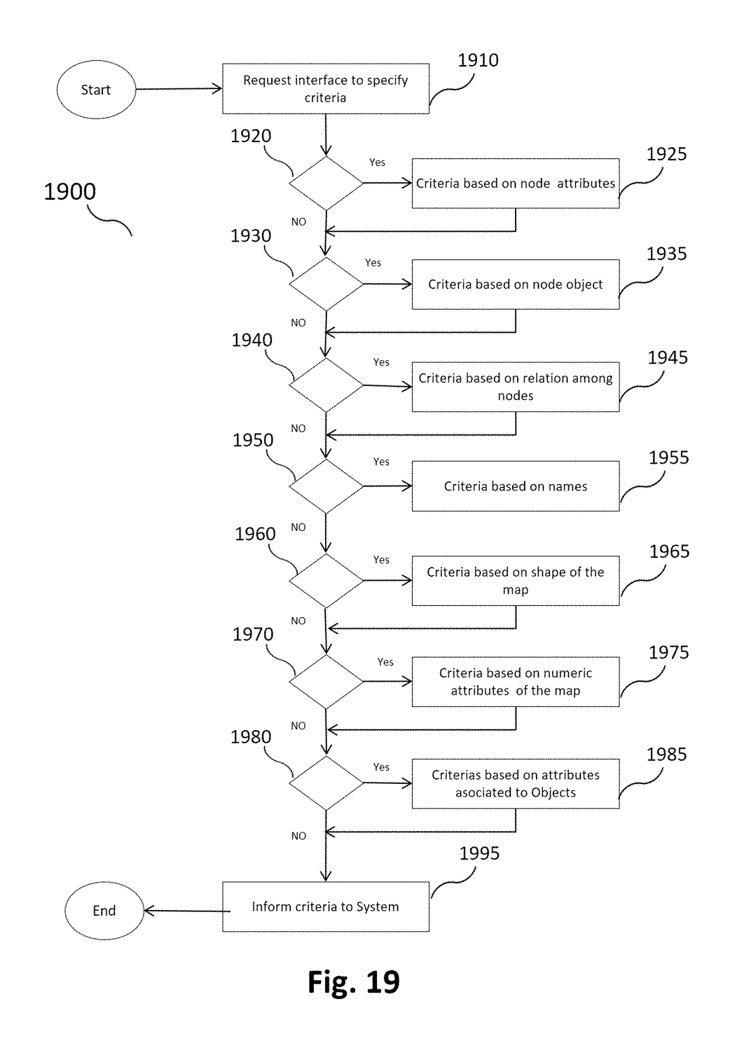

Referring to FIG. 19, in an exemplary embodiment, a diagram illustrates some of the criteria that may be used in the process to define new Map Views. The different types of criteria shown in the FIG. 19 are neither mandatory nor exclusive.
Activity 1910 may consist in requesting the system to provide an interface able to specify criteria. Such interface may be of any type and the way to specify criteria may be done by means of natural language or by filling special forms, or with a query language, etc.
Activity 1925 may consists of selecting criteria were reference may be made to Node attributes such as, for example, type of node, color, associated tag node, type of information associated to the node, markers associated to the node, etc.
Activity 1935 may refers to selection criteria where reference may be made to attributes of Object provided by the system that may be associated to the Node.
Activity 1945 may refers to selection criteria where reference may be made to existing relations among Map nodes, such as for example: antecessor or successor of another Node in the Map, Nodes within a given distance, Nodes that are part of the same Map view, Nodes belonging a certain demarcated Map zone, etc.
Activity 1955 may refer to selection criteria where reference may be done to different names that may be used anywhere in the application, such as for example: the place in which appears a specific name, names similarities, names having a common root, common or similar names for different elements, etc.
Activity 1965 may refers to selection criteria where references may be done to some Map special characteristics, such as for example: Nodes that make part of certain geometrical shapes (triangles, circles, etc.), nodes that lay at a certain distance to other nodes, nodes that lay in special map points (up, down, at the center, to the right, to the left, etc.), etc.
Activity 1975 may refer to selection criteria where reference may be made to some numeric Map attributes, such as for example: quantity of Nodes in a certain region, quantity of Nodes in a Map View, quantity of Nodes of a certain type, quantity of Nodes that have the same type of Object, etc.
Activity 1985 may refer to selection criteria where reference may be done to actions that may be associated with the Objects that appear as verbs used in Objects attributes.
Activity 1995 may give back to the System, the defined criteria for a Map views construction.

FIG. 20, in an exemplary embodiment, a block diagram shows the Method that can be used to construct an Enterprise Application using the capabilities offered by the System. In this diagram, some blocks correspond to concepts of the design methodology known as “Domain Driven Design” (DDD). Working with the Method may be facilitated by the functionality provided by the System.
Activity 2010 “Define Bounded Context” may corresponds to what is described in technical literature on DDD, but may be focused on the purpose of isolating the Business Logic 110 from the App Infrastructure 120, as described before.
Activity 2030 may consist on entity identification according to DDD methodology.
Activity 2050 may consist on defining the ubiquitous language according to DDD methodology.
Activity 2040 may consist in the identification of the business rules, that may be part of DDD's ubiquitous language associated to the business of to the Enterprise Application to be developed. The Methods of this Application may not establish any particular way to express business rules. Business Rules may be the primary declaration of intentions and characteristics of an Enterprise Application. They may express the particular way in which the defined business may be supported by the Enterprise Application. Business rules may not refer to “how” if not to “what”, and therefore may exclude any element of the solution itself. The process of recognizing what is and what is not a Business Rule may be a gradual process, which may be refined during the development of the Enterprise Application. At the end of the construction of the application, the rules may become sufficiently detailed and clearly represented.
Activity 2060 may define each of the Objects that may be required to develop the Enterprise Application.
Box 2070 may represent functionality that the System may provide to facilitate working with the Method.
Box 2020 represents the fact that the Method may be an iterative process, as it may by exposed by the loop containing activity 2025.

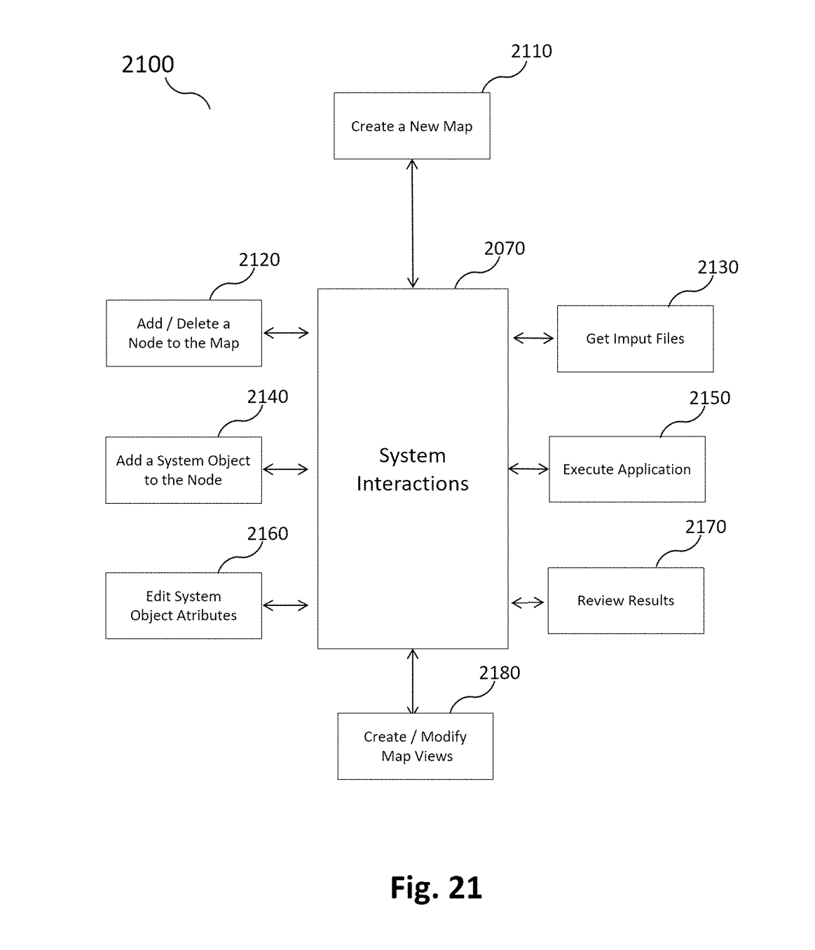

FIG. 21, in an exemplary embodiment, a block diagram that may illustrates interactions with the System, that me be helpful to support the Method
Box 2110 may allow the creation of a new Map for a new Business Application.
Box 2120 may allow adding or deleting Nodes to the Map.
Box 2140 may allow to associate to the Map Nodes, Objects of the System, as well as to delete existing associations.
Box 2160 may allow to edit Objects' attributes.
Box 2130 may allow to define Input Objects and make them available for processing.
Box 2150 may allow to execute the Business Application.
Box 2150 may allow to review results generated by the Business Application execution.
Box 2180 may allow to create or modify Map Views.

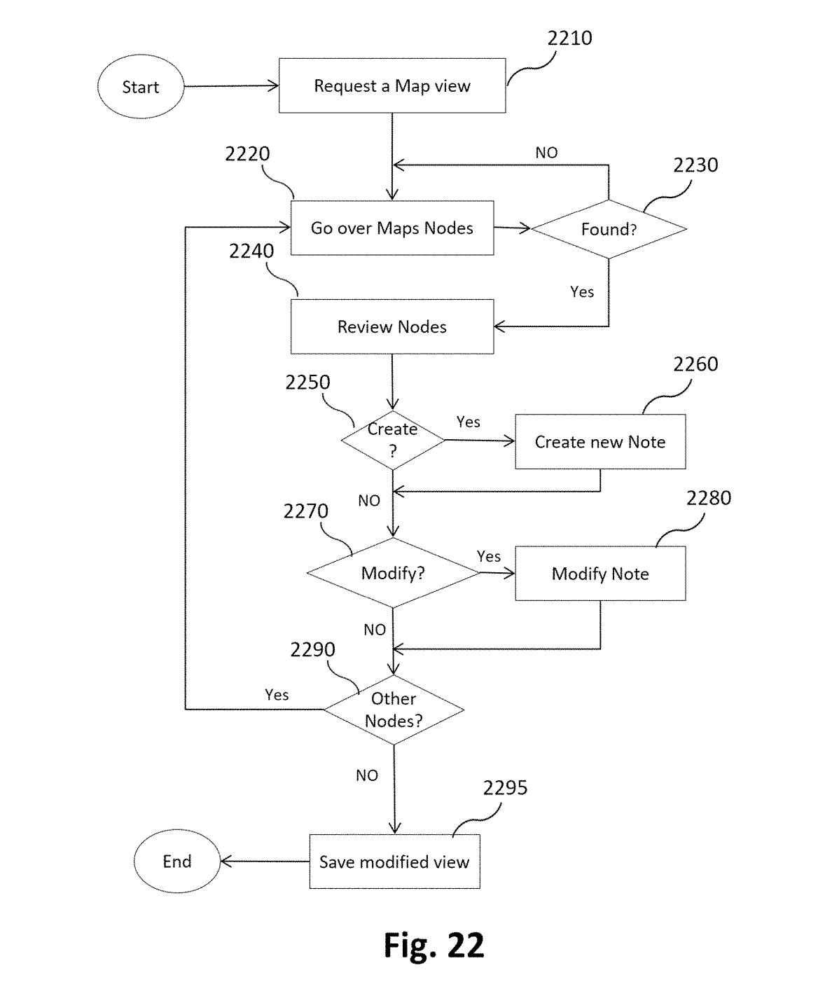

FIG. 22, in an exemplary embodiment, a block diagram shows a process that may generate Enterprise Application documentation, that may be performed by adding text notes to the Nodes that conform each of the Enterprise Application Map Views.
Box 2210 may allow to request a Map View to work with.
Box 2220 may allow to navigate thru the different Nodes in the Map View.
Box 2240 may allow the review notes associated to a Node.
Box 2260 may allow to create a new note.
Box 2280 may allow to modify an existing note.
Box 2295 may allow to save the Map View, that contains the updated set of notes that were added, modified or deleted and also the unmodified notes.

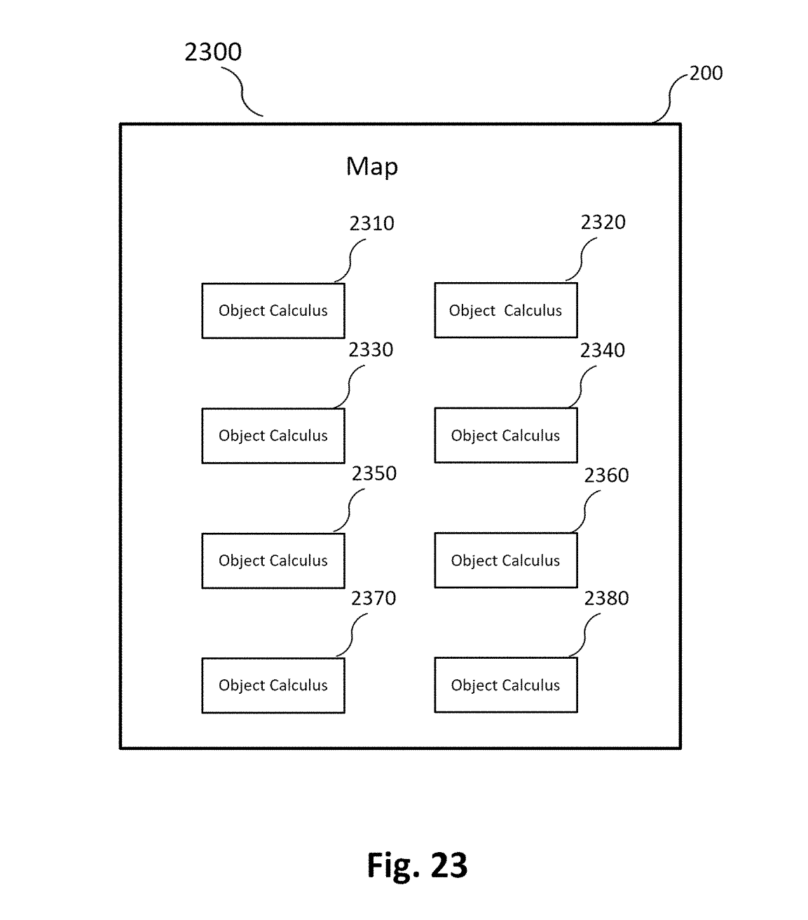

FIG. 23, shows a block diagram of a Map 200, that as an example, contains Calculus Objects, 2310, 2320, 2330, 2340, 2350, 2360, 2370, 2380. Each of the Calculus Objects could be defined using four blocks as shown in FIG. 17, so as a whole, these Calculus Objects may create 24 columns in a Worksheet. The system 100 may have Maps with as many Calculus Objects as needed, and each of those built using a minimal number of blocks.

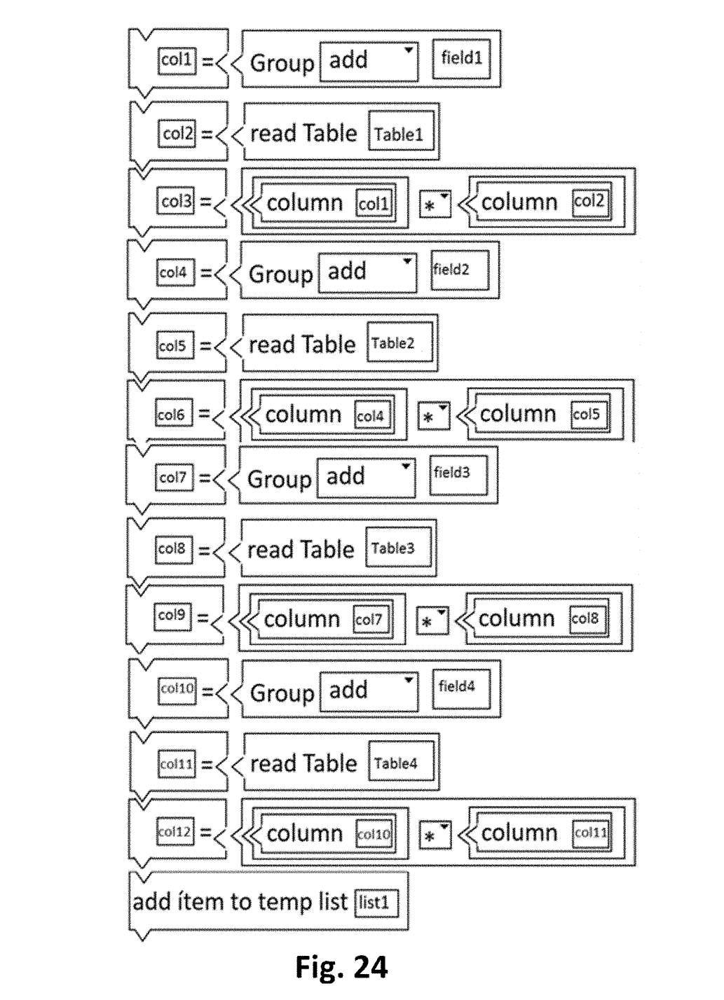

FIG. 24, shows a block diagram as a possible example to indicate how would it be to have only one Calculus Object to fill up the same 24 columns referenced in FIG. 23. This show that Method and System can permit to develop complex Enterprise Application made by many small Calculus Object.

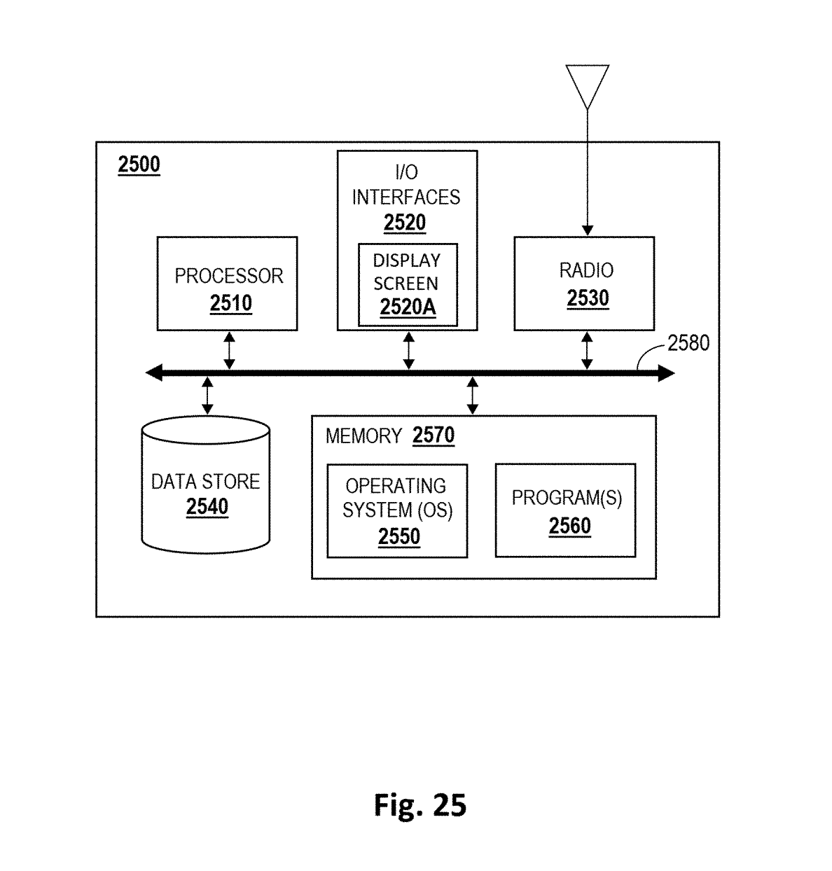

Referring to FIG. 25, in an exemplary embodiment, a block diagram illustrates an electronic device 2500, which may be used in the system 100 to perform steps of methods disclosed herein. The term “electronic device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, or any electronic device capable of running computer software and displaying information to a user. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The electronic device 2500 can be a digital device that, in terms of hardware architecture, generally includes a processor 2510, input/output (I/O) interfaces 2520, a radio 2530, a data store 2540, and memory 2570. It should be appreciated by those of ordinary skill in the art that FIG. 25 depicts the electronic device 2500 in an oversimplified manner, and a practical embodiment may include additional components and suitably configured processing logic to support known or conventional operating features that are not described in detail herein. The components (2510, 2520, 2530, 2540, and 2570) are communicatively coupled via a local interface 2580. The local interface 2580 can be, for example but not limited to, one or more buses or other wired or wireless connections, as is known in the art. The local interface 2580 can have additional elements, which are omitted for simplicity, such as controllers, buffers (caches), drivers, repeaters, and receivers, among many others, to enable communications. Further, the local interface 2580 may include address, control, and/or data connections to enable appropriate communications among the aforementioned components.

The processor 2510 is a hardware device for executing software instructions. The processor 2510 can be any custom made or commercially available processor, a central processing unit (CPU), an auxiliary processor among several processors associated with the electronic device 2500, a semiconductor-based microprocessor (in the form of a microchip or chip set), or generally any device for executing software instructions. When the electronic device 2500 is in operation, the processor 2510 is configured to execute software stored within the memory 2570, to communicate data to and from the memory 2570, and to generally control operations of the electronic device 2500 pursuant to the software instructions. In an exemplary embodiment, the processor 2510 may include a mobile optimized processor such as optimized for power consumption and mobile applications. The I/O interfaces 2520 can be used to receive user input from and/or for providing system output. User input can be provided via, for example, a keypad, a touch screen, a scroll ball, a scroll bar, buttons, bar code scanner, and the like. System output can be provided via a display screen 2520A or display device such as a liquid crystal display (LCD), touch screen, and the like. The I/O interfaces 2520 can also include, for example, a serial port, a parallel port, a small computer system interface (SCSI), an infrared (IR) interface, a radio frequency (RF) interface, a universal serial bus (USB) interface, and the like. The I/O interfaces 2520 can include a graphical user interface (GUI) that enables a user to interact with the electronic device 2500.

The radio 2530 enables wireless communication to an external access device or network. Any number of suitable wireless data communication protocols, techniques, or methodologies can be supported by the radio 2530, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 2540 may be used to store data. The data store 2540 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 2540 may incorporate electronic, magnetic, optical, and/or other types of storage media.

The memory 2570 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 2570 may incorporate electronic, magnetic, optical, and/or other types of storage media. Note that the memory 2570 may have a distributed architecture, where various components are situated remotely from one another, but can be accessed by the processor 2510. The software in memory 2570 can include one or more software programs, each of which includes an ordered listing of executable instructions for implementing logical functions. In the example of FIG. 25, the software in the memory 2570 includes a suitable operating system (O/S) 2550 and programs 2560. The operating system 2550 essentially controls the execution of other computer programs, and provides scheduling, input-output control, file and data management, memory management, and communication control and related services. The programs 2560 may include various applications, add-ons, etc. configured to provide end user functionality with the electronic device 2500. For example, exemplary programs 2560 may include, but not limited to, a application processing engine 192, a map editor engine 193, a display engine 194, a web browser, social networking applications, streaming media applications, games, mapping and location applications, electronic mail applications, financial applications, and the like. In a typical example, the end user typically uses one or more of the programs 2560 along with a network such as the system 100.

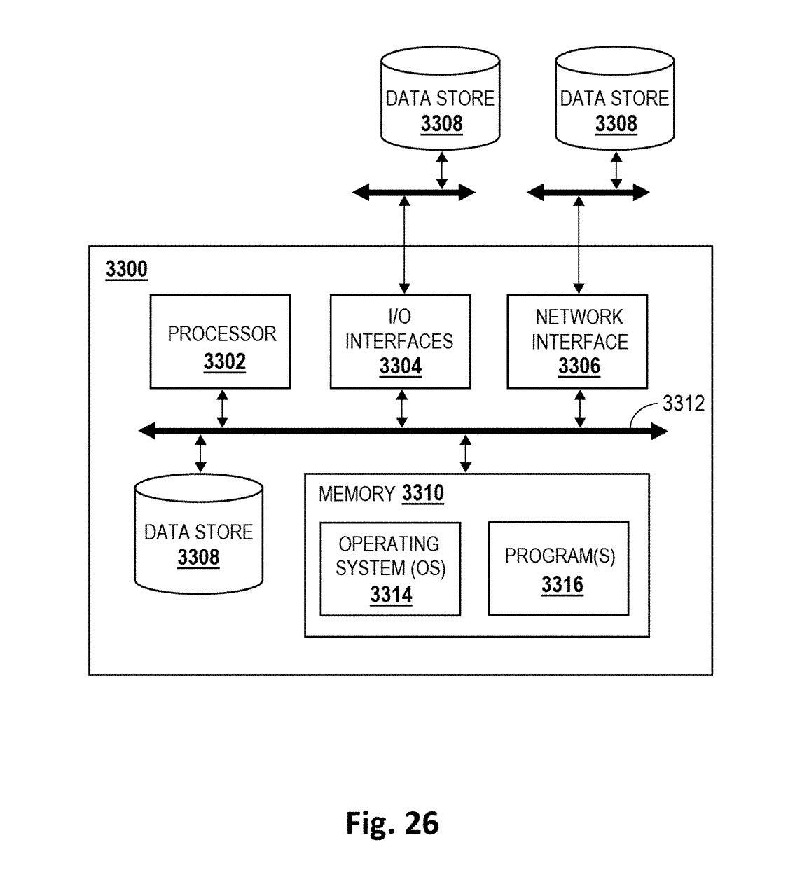

Referring to FIG. 26, in an exemplary embodiment, a block diagram illustrates a server 3300 which may be used in the system 100, in other systems, or standalone. The server 3300 may be a digital computer that, in terms of hardware architecture, generally includes a processor 3302, input/output (I/O) interfaces 3304, a network interface 3306, a data store 3308, and memory 3310. It should be appreciated by those of ordinary skill in the art that FIG. 26 depicts the server 3300 in an oversimplified manner, and a practical embodiment may include additional components and suitably configured processing logic to support known or conventional operating features that are not described in detail herein. The components (3302, 3304, 3306, 3308, and 3310) are communicatively coupled via a local interface 3312. The local interface 3312 may be, for example but not limited to, one or more buses or other wired or wireless connections, as is known in the art. The local interface 3312 may have additional elements, which are omitted for simplicity, such as controllers, buffers (caches), drivers, repeaters, and receivers, among many others, to enable communications. Further, the local interface 3312 may include address, control, and/or data connections to enable appropriate communications among the aforementioned components.

The processor 3302 is a hardware device for executing software instructions. The processor 3302 may be any custom made or commercially available processor, a central processing unit (CPU), an auxiliary processor among several processors associated with the server 3300, a semiconductor-based microprocessor (in the form of a microchip or chip set), or generally any device for executing software instructions. When the server 3300 is in operation, the processor 3302 is configured to execute software stored within the memory 3310, to communicate data to and from the memory 3310, and to generally control operations of the server 3300 pursuant to the software instructions. The I/O interfaces 3304 may be used to receive user input from and/or for providing system output to one or more devices or components. User input may be provided via, for example, a keyboard, touch pad, and/or a mouse. System output may be provided via a display device and a printer (not shown). I/O interfaces 3304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 3306 may be used to enable the server 3300 to communicate on a network, such as the Internet, a wide area network (WAN), a local area network (LAN), and the like, etc. The network interface 3306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 3306 may include address, control, and/or data connections to enable appropriate communications on the network. A data store 3308 may be used to store data. The data store 3308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 3308 may incorporate electronic, magnetic, optical, and/or other types of storage media. In one example, the data store 3308 may be located internal to the server 3300 such as, for example, an internal hard drive connected to the local interface 3312 in the server 3300. Additionally, in another embodiment, the data store 3308 may be located external to the server 3300 such as, for example, an external hard drive connected to the I/O interfaces 3304 (e.g., SCSI or USB connection). In a further embodiment, the data store 3308 may be connected to the server 3300 through a network, such as, for example, a network attached file server.

The memory 3310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 3310 may incorporate electronic, magnetic, optical, and/or other types of storage media. Note that the memory 3310 may have a distributed architecture, where various components are situated remotely from one another, but can be accessed by the processor 3302. The software in memory 3310 may include one or more software programs, each of which includes an ordered listing of executable instructions for implementing logical functions. The software in the memory 3310 includes a suitable operating system (O/S) 3314 and one or more programs 3316. The operating system 3314 essentially controls the execution of other computer programs, such as the one or more programs 3316, and provides scheduling, input-output control, file and data management, memory management, and communication control and related services. The one or more programs 3316 may be configured to implement the various processes, algorithms, methods, techniques, etc. described herein. Exemplary programs 3316 may include, but are not limited to, an application processing engine 192, a map editor engine 193, and a display engine 194.

Turning now to FIGS. 1C and 27-29, in some embodiments, the Business Logic 110 may be processed in the Cloud 150 as a Serverless Function 151 which allows all the abstraction of all operational infrastructure (Hardware and Software) thereby operating as a service, just as if one were calling a function inside from the same program. A benefit of Serverless Function processing 151 is that it automatically adjusts to the increase or decrease of the workload and is paid for the effective use of resources, thereby providing more efficient processing via cloud computing 150.

In preferred embodiments, the Business Logic 110 may utilize a special type of Serverless Function, which can be called Abstract Function 152 in the context of this invention. The term “Abstract Function” as used herein is a new concept and cannot be used as a known technical term. Abstract Function 152 may provide a generic processing capacity that, once deployed in the cloud, can run any application that has been defined using a graphical model such as the one described above. The Abstract Function 152 just needs when you call it, once provided the input parameters provided by the business application 191 (Business Logic Input 157) and its map 200, the Abstract Function 152 may process the business application 191. In further preferred embodiments, the map 200 (Graphical Model of the business application 191) may be stored one or more Text Files, thereby allowing the map 200 to pass as parameter of the call into the Abstract Function 152.

A benefit of the Abstract Function 152, is that it allows for the development and modification of applications which run in the cloud, cheaply and with very good response times, without having to deploy them in the cloud. Since these applications are defined in the graphical form of the map 200, the modifications to them can be made by users 101 without computer programming experience.

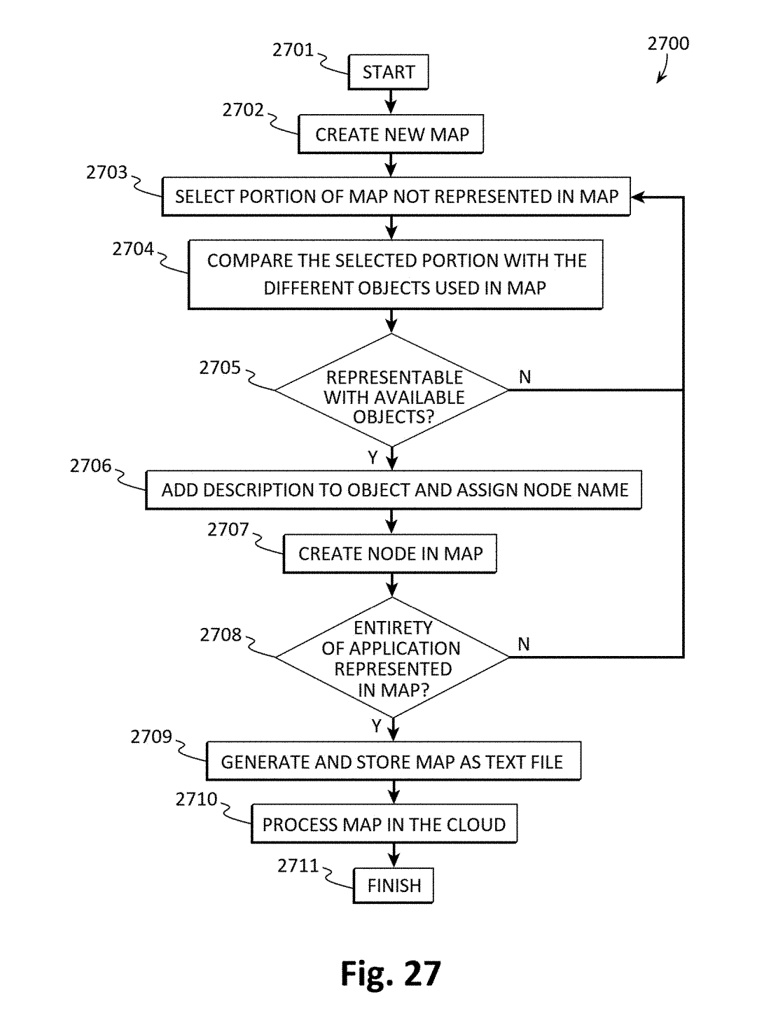

FIG. 27 illustrates a method of creating a business application 191 as an executable graphical model (“the method”) 2700 according to various embodiments. In some embodiments, the method 2700 may start 2701 and a new map 200 may be created by a map editor engine 193 in step 2702. The map 200 may be graphically displayed to a business user 101 as having one or more graphical elements by the display engine 194 which will be used to represent the business rules of the business application 191 that results from the map 200. In preferred embodiments, the map 200 may be created with a single node corresponding to the root of the tree in the system database.

In step 2703 a portion of the map 200 may be selected by the map editor engine 193, according to user 101 input, which has not been previously represented in the map 200. This portion corresponds to a portion of the business application 191 that has not been entered in the system 100.

In step 2704 the selected portion may be compared with the different objects that are used in the map 200 by the map editor engine 193, optionally according to user 101 input, to see if any of the graphical elements may correspond to the selected portion of the map 200 (the graphical elements being a graphical depiction of computer code which may be used to generate that portion of the business application 191).

In decision block 2705, the map editor engine 193, optionally according to user 101 input, may determine if the selected portion is able to be represented with one of the available objects and/or with a simple combination of objects. If it is not possible, the method 2700 may proceed to step 2703. If the selected portion is able to be represented with one of the available objects the method may proceed to step 2706. If the selected portion is able to be represented with a combination of objects, then the portion may be subdivided into smaller portions which may each be represented with an available object, one of them may selected, the method 2700 may proceed to step 2703 for the selected portion.

In step 2706, the corresponding description for the object of the selected portion may be added to the object, as described above, and assigned a node name by the map editor engine 193.

In step 2707, the map editor engine 193 may create or store the node in the map 200. Preferably, the map 200 node may be created in the position which is most intuitive to the business user 101, and it may be given a chosen name and associated with the corresponding description by the map editor engine 193.

In decision block 2708, the map editor engine 193, optionally according to user 101 input, may determine if any portion in the business application 191 is not represented in the map 200. If a portion is not represented in the map 200, the method 2700 may proceed to step 2703. If all portions are represented, the method 2700 may proceed to step 2709.

In step 2709, the map 200, having the graphical elements that graphically depict the business rules of the business application, may be generated and stored in a database of the system 100 by map editor engine 193. In some embodiments, the map 200 may be generated and stored as a text file.

In step 2710, the map 200, optionally in the form of a text file, may be submitted for processing in the cloud. After step 2710, the method 2700 may finish.

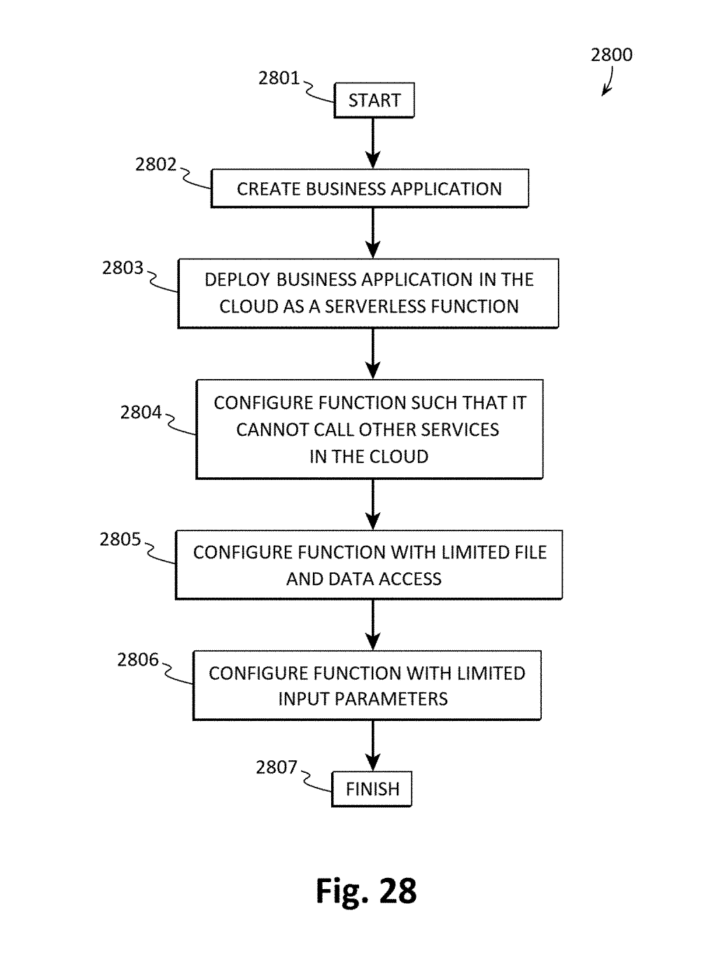

FIG. 28 depicts a method of creating an abstract function (“the method”) 2800 according to various embodiments described herein. In some embodiments, the method 2800 may enable one or more engines of the system 100, such as an application processing engine 192 and a map editor engine 193, to be processed via abstract function preferably on a serverless computing platform.

In some embodiments, the method 2800 may start 2801 and a business application 191 may be generated by a map editor engine 193 in step 2802 according to the present disclosure, such as via method 2700. The business application 191 may function as a computational engine when processed by an application processing engine 192 of a computing platform, such as a serverless computing platform.

In step 2803, the business application 191 functioning as a computational engine may be deployed in the cloud as a serverless function. For example, the business application 191 may be deployed using the Amazon AWS Lambda Function. In some embodiments, the business application 191 may be deployed in the cloud as a serverless function optionally via a display engine 194 according to user 101 input.

In step 2804 the serverless function may be configured such that it cannot call other services in the cloud. Continuing the above example, the Lambda Function may be configured such that it cannot call other services in the cloud. In some embodiments, the serverless function may be configured optionally via a display engine 194 according to user 101 input.

In step 2805 the serverless function may be configured with limited file and data access. Continuing the above example, the Lambda Function may be configured, such that the only files it can read and/or write, are those that are defined when this Function is called. In some embodiments, the serverless function may be configured optionally via a display engine 194 according to user 101 input.

In step 2806 the serverless function may be configured with limited input parameters. Continuing the above example, the Lambda function may be configured, such that it can only receive two parameters for input, one with the input files, preferably contained in the App Infrastructure 120, and the other with the map 200. In some embodiments, the serverless function may be configured optionally via a display engine 194 according to user 101 input. After step 2807, the method 2800 may finish 2807.

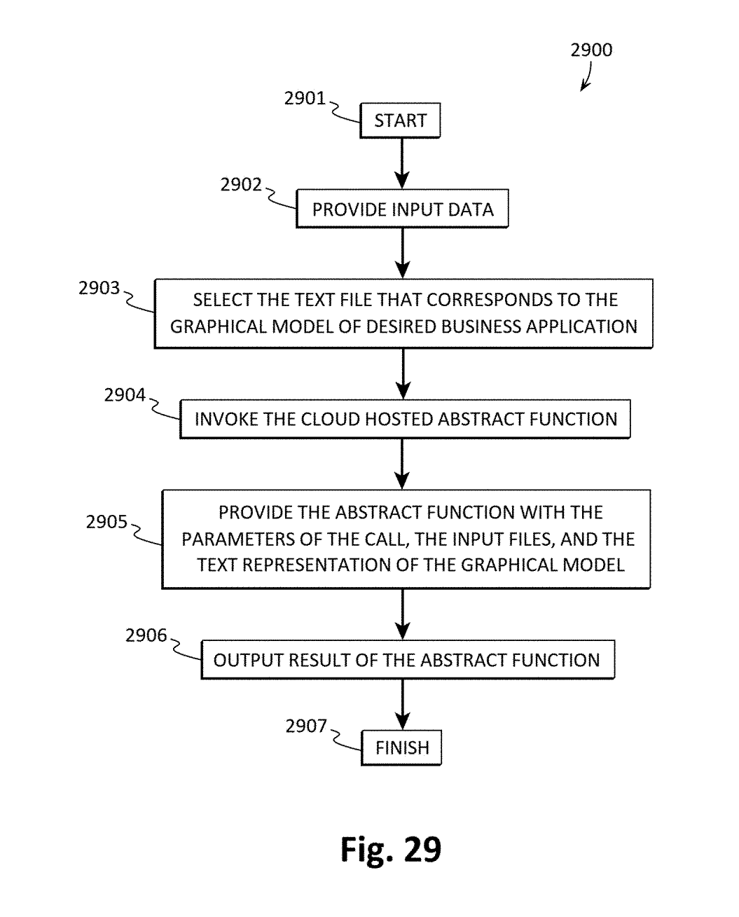

FIG. 29 show a block diagram of an example method of executing an abstract function (“the method”) 2900 according to various embodiments described herein. In some embodiments, the method 2900 may start 2901 and input data may be provided to the application processing engine 192 operating as an abstract function on a serverless computing platform in step 2902. Generally, this may include the input data that the application needs to be executed.

In step 2903 the text file that corresponds to the graphical model of a desired business application 191 (such as which may be generated by method 2700) may be selected by the application processing engine 192 optionally via user 101 input provided by a display engine 194. For example, the text file that corresponds to the graphical model map 200 that a user 101 desires to run may be selected.

In step 2904 the cloud hosted abstract function (such as which may be generated via method 2800) may be invoked by the application processing engine 192. For example, the Abstract Function which is hosted as a Lambda function in the AWS cloud may be invoked.

In step 2905 the abstract function may be provided with the parameters of the call, the input files, and the text file representation of the graphical model (such as which may be generated by method 2700) by the application processing engine 192.

In step 2906 the result of the abstract function may be output. In some embodiments, the output may be provided to the application processing engine 192. In other embodiments, the output may be provided to the display engine 194 to be displayed on a display screen 2520A. The output received as a result of the Abstract Function comprises the output data defined in the Graphical model or map 200 of the business application 191. After step 2906, the method 2700 may finish 2907.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer implemented system for development of visual business applications, the system comprising:
an electronic device having a display screen and an input interface for receiving input from a user;
a computing platform having a processor, a memory in communication with the processor;
a map, stored in the memory, having a node describing an object class;
map editor logic stored in the memory and executable by the processor, the map editor logic configured to receive input describing an event for object creation from the user, wherein the map editor logic is configured to generate a map, stored in the memory, having a node having an object class comprising the data describing the event for object creation, and wherein the map editor logic is configured to generate a business application, stored in the memory, comprising a Business Logic that exchanges data with a App Infrastructure, wherein the Business Logic comprises a business rule and the map, and wherein the App Infrastructure comprises a computational element; and
application processing logic stored in the memory and executable by the processor, the application processing logic is configured to process the business application using the business rule of the Business Logic to generate an output, the output formed by processing the computational element of the App Infrastructure according to the business rule of the head; and
display logic stored in the memory and executable by the processor, the display logic configured to display the output on the display screen of the electronic device.

2. The system of claim 1, further comprising a server in communication with the electronic device, wherein the server is the computing platform.

3. The system of claim 1, wherein the computing platform is a serverless computing platform, and wherein the application processing logic is processed via serverless function.

4. The system of claim 3, wherein the map editor logic and the application processing logic are processed via abstract function.

5. The system of claim 3, wherein the map is stored as a text file.

6. The system of claim 1, wherein the display logic is configured to graphically depict the business rule and map on the display screen of the electronic device as graphic elements.

7. The system of claim 6, wherein the application processing logic is configured to transform the graphic elements into compiled code.

8. The system of claim 1, wherein the object class is selected from the group consisting of Input, Output, Table, Assembly, Calculus, Constant, Container, Grouper, and Application.

9. The system of claim 1, wherein the map comprises a container having an object assembly.

10. The system of claim 1, wherein the map comprises a container having an object input.

11. The system of claim 1, wherein the map comprises a container having an object grouper.

12. A computer implemented system for development of visual business applications, the system comprising:
an electronic device having a display screen and an input interface for receiving input from a user;
a computing platform having a processor, a memory in communication with the processor, wherein the computing platform is a serverless computing platform, and wherein the application processing logic is processed via abstract function;
a map, stored in the memory, having a node describing an object class;
map editor logic stored in the memory and executable by the processor, the map editor logic configured to receive input describing an event for object creation from the user, wherein the map editor logic is configured to generate a map, stored in the memory, having a node having an object class comprising the data describing the event for object creation, and wherein the map editor logic is configured to generate a business application, stored in the memory, comprising a Business Logic that exchanges data with a App Infrastructure, wherein the Business Logic comprises a business rule and the map, and wherein the App Infrastructure comprises a computational element; and
application processing logic stored in the memory and executable by the processor, the application processing logic is configured to process the business application using the business rule of the Business Logic to generate an output, the output formed by processing the computational element of the App Infrastructure according to the business rule of the head; and
display logic stored in the memory and executable by the processor, the display logic configured to display the output on the display screen of the electronic device.

13. The system of claim 12, further comprising a server in communication with the electronic device, wherein the server is the computing platform.

14. The system of claim 13, wherein the map is stored as a text file.

15. The system of claim 12, wherein the display logic is configured to graphically depict the business rule and map on the display screen of the electronic device as graphic elements.

16. The system of claim 15, wherein the application processing logic is configured to transform the graphic elements into compiled code.

17. The system of claim 12, wherein the object class is selected from the group consisting of Input, Output, Table, Assembly, Calculus, Constant, Container, Grouper, and Application.

18. The system of claim 12, wherein the map comprises a container having an object assembly.

19. The system of claim 12, wherein the map comprises a container having an object input.

20. The system of claim 12, wherein the map comprises a container having an object grouper.
